(19) United States
(12) Patent Application Publication
(10) Pub. No.: US 2009/0016188 A1
(43) Pub. Date: Jan. 15, 2009

(54) MULTI-LAYER INFORMATION RECORDING MEDIUM, INFORMATION RECORDING/REPRODUCING DEVICE AND MULTI-LAYER INFORMATION RECORDING MEDIUM MANUFACTURING METHOD

(76) Inventors: Atsushi Nakamura, Osaka (JP); Morio Tomiyama, Nara (JP)

Correspondence Address: WENDEROTH, LIND & PONACK L.L.P., 2033 K. STREET, NW, SUITE 800, WASHINGTON, DC, 20006, US

(21) Appl. No.: 12/281,530

(22) PCT Filed: Feb. 21, 2007
(86) PCT No.: PCT/JP2007/053213

§ 371 Date: Sep. 3, 2008

(30) Foreign Application Priority Data
Mar. 3, 2006 (JP) 2006-057399

(51) Int. Cl. G11B 3/74

(52) U.S. Cl. 369/94

(57) ABSTRACT

By assuring lower compatibility with information recording media already on the market or of known formats, information is recorded/reproduced on/from a multi-layer information recording medium of a new format using an information recording/reproducing device already widely in use. The multi-layer information recording medium includes a plurality of layered information planes L0 to L3, which include a first and a second information planes L0, L1 each having a BCA and a pre-recorded area (first reflecting surface) for reflecting a light with a specified first reflected light power when the light is incident and a third and a fourth information planes L2, L3 each having a low reflectivity area (second reflecting surface) for reflecting the light with a second reflected light power smaller than the first reflected light power.

### TECHNICAL FIELD

The present invention relates to a multi-layer information recording medium having a plurality of layered information planes and designed to record or reproduce information by light, a multi-layer information recording medium manufacturing method and an information recording/reproducing device for recording information such as digital video information on a multi-layer information recording medium with high density and reproducing information recorded on a multi-layer information recording medium.

### BACKGROUND ART

Optical memory technology using an optical disc medium having a pit pattern as a high-density/high capacity recording medium has been put to practical use while extending its application to digital versatile discs (DVDs), video discs, document file discs and further to data files. For example, functions required to successfully recording and reproduce information on and from an optical disc medium with high reliability using a light beam focused to have a small diameter of 1 μm or below are broadly classified into a focusing function of forming a diffraction-limited microspot, a focus controlling function (focus servo) of an optical system, a tracking controlling function and a pit signal (information signal) detecting function.

In recent years, in order to further increase the recording density of an optical disc medium, it has been studied to increase a numerical aperture (NA) of an objective lens for forming a diffraction-limited microspot by focusing a light beam on the optical disc medium. However, since spherical aberration resulting from an error in the thickness of a base member for protecting a recording layer of the optical disc medium is in proportion to the quadruplicate of NA, it is drastically increased in the case of increasing NA, for example, to 0.8, 0.85 and the like. Accordingly, it is unavoidable to provide the optical system with means for correcting the spherical aberration in the case of increasing the numerical aperture.

A method disclosed in patent literature 1 is, for example, known as such a method for correcting spherical aberration. FIG. 19 is a diagram showing the construction of a conventional optical disc device shown in patent literature 1. In FIG. 19, three spherical aberration correction amounts including an aberration correction amount (a) for an spherical aberration correction amount of 0 mλ, an aberration correction amount (b) for correcting the spherical aberration of an optical disc medium having a thin base member with respect to a reference thickness and an aberration correction amount (c) for correcting the spherical aberration of an optical disc medium having a thick base member with respect to the reference thickness with the reference thickness set to 100 μm are set beforehand for each information plane of the optical disc medium for performing a focus control in aberration correction amount switching means 614. The aberration correction amount switching means 614 selects and switches to a suitable spherical aberration correction amount based on a disc discrimination signal 613 from disc discriminating means 612. Thus, in the case of recording or reproducing information on or from a high-density optical disc medium using an objective lens with a large NA, a spherical aberration correction suitable for the information plane of the optical disc medium for performing a focus control is made, wherefore the focus control can be stably performed.

In recent years, recordable optical disc media such as two-layer DVD-Rs having a capacity of 8.5 GB, rewritable optical disc media such as two-layer Blu-ray disc media having a capacity of 50 GB and recording and reproducing information using a blue laser light source and the like have been commercialized as optical disc media having two information planes on one side thereof (two-layer optical disc media). Such two-layer optical disc media can have about twice the storage capacities of one-layer optical disc media. A format disclosed in patent literature 2 is known as a disc format of such multi-layer optical disc media having two or more information planes.

According to the format disclosed in patent literature 2, a distance from the outer surface of a cover layer, on which laser light is incident, to an information plane L0 as a first layer in a disc thickness direction is equal in one-layer optical disc media having one information plane from a laser incident side and multi-layer optical disc media having two or more information planes. In a multi-layer optical disc medium, a second information plane L1 and succeeding information planes are formed at positions closer to the outer surface of the cover layer than the first information plane L0. Thus, in one-layer optical disc media and multi-layer optical disc media having two, three or more information planes, recording layers (e.g. recording layers made of phase-changing recording films) as the first layers can be similarly formed on polycarbonate substrates, whereby a manufacturing process can be shared and similar recording/reproducing characteristics can be obtained for one-layer optical disc media and multi-layer optical disc media.

Since the second and succeeding recording layers are formed at positions closer to the outer surface of the cover layer than the first layer in the multi-layer optical disc media, distances between the second and succeeding recording layers and the outer surface of the cover layer become shorter. In other words, the cover layer thickness becomes thinner when viewed from the respective layers. Thus, a tilt (inclination) permissible angle between the optical disc medium and the light beam increases. In other words, it is possible to improve recording/reproducing characteristics and disc productivity and to promote cost reduction since tilt margins of the second and succeeding recording layers can be relaxed as compared with those of the recording films in the first layers.

A method disclosed in patent literature 3 is, for example, known as a method for the focus control of the above two-layer optical disc medium. Patent literature 3 discloses a method for reliably pulling light in for focusing on the information planes even if the level of the total reflected light power from the respective information planes is reduced as in a multi-layer optical disc medium.

Further, patent literature 4 discloses an optical recording medium having a recording surface compatible with a BD format and a recording surface compatible with a DVD format. The optical recording medium in patent literature 4 is interchangeably loadable into optical recording/reproducing devices compatible with different formats.

The conventional spherical aberration correction method disclosed in patent literature 1 is a method for discriminating the type of an optical disc medium using the disc discriminating means and correcting the spherical aberration correction amount corresponding to the thickness of the recording surface, for which a focus control is performed, using the aberration correction amount switching means. However, in an optical disc device supposing optical disc media having up to two recording surfaces, if an optical disc medium outset the initially set range, e.g. an optical disc medium having four information recording surfaces from a laser incident surface on one side is inserted, an access control to the inserted optical disc medium is stopped by executing an error processing to, for example, discharge the optical disc medium, wherefore it is not possible to record or reproduce information on or from the optical disc medium. Alternatively, even if the optical disc device operates, there has been a problem of being unable to start the optical disc medium.

In the conventional multi-layer optical disc medium disclosed in patent literature 2, the information planes are formed at positions closer to the outer surface of the cover layer in the disc thickness direction from the laser incident side. In this case, there is no problem if an optical disc device capable of recording/reproducing on/from a multi-layer optical disc medium is designed and developed at the same time as the multi-layer optical disc medium is designed and developed. However, in a legacy drive available before all the types of formats of multi-layer optical disc media are determined, there is a limit in recording and reproducing information on or from optical disc media of old formats. For example, if an optical disc medium having two or more information planes on one side such as a four-layer optical disc medium is inserted into an optical disc device compatible with two-layer optical disc media already on the market, it is impossible to correctly discriminate the inserted optical disc medium as a four-layer optical disc medium.

Even if the distances of the first information plane L0 and the second information plane L1 out of the plurality of information planes are equal to those of the conventionally available two-layer optical disc media, it is not possible to record or reproduce information on or from the four-layer optical disc medium if the inserted optical disc medium is discriminated not to be a two-layer optical disc medium at the time of disc discrimination. For example, if a disc having two layers of information planes and available before the format of a disc having four layers of information planes is disclosed is inserted, the four-layer optical disc medium is ejected depending on a start procedure performed upon starting the optical disc device, where it is not possible to record or reproduce information on or from the four-layer optical disc medium of a next format.

### [Patent Literature 1]

Japanese Unexamined Patent Publication NO. 2002-373441

### [Patent Literature 2]

Japanese Unexamined Patent Publication NO. 2003-346379

### [Patent Literature 3]

Pamphlet of International Publication No. 02/067250

### [Patent Literature 4]

Japanese Unexamined Patent Publication NO. 2006-236509

### DISCLOSURE OF THE INVENTION

The present invention was developed to solve the above problems and an object thereof is to provide a multi-layer information recording medium, an information recording/reproducing device and a multi-layer information recording medium manufacturing method which are capable of assuring lower compatibility with information recording media already on the market or of known formats and enabling information to be recorded/reproduced on/from a multi-layer information recording medium of a new format using an information recording/reproducing device already widely in use.

One aspect of the present invention is directed to a multi-layer information recording medium, comprising a plurality of layered information planes and adapted to record or reproduce information by light, wherein the plurality of information planes include at least one information plane having a first reflecting surface for reflecting light with a first reflected light power when the light is incident and another information plane having a second reflecting surface for reflecting the light with a second reflected light power smaller than the first reflected light power.

Another aspect of the present invention is directed to a information recording/reproducing device for recording or reproducing information on or from a multi-layer information recording medium including a plurality of layered information planes, the plurality of information planes including at least one information plane having a first reflecting surface for reflecting light with a first reflected light power when the light is incident and another information plane having a second reflecting surface for reflecting the light with a second reflected light power smaller than the first reflected light power, the information recording/reproducing device comprising a laser light emitter for emitting laser light for recording or reproducing a signal on or from a signal track of the multi-layer information recording medium; a spherical aberration correcting section for correcting the spherical aberration of the laser light; a controller for controlling the focal position of the laser light according to the information plane, to which the laser light is emitted; and a medium discriminator for discriminating the number of the information planes by emitting laser light to the first reflecting surface of the multi-layer information recording medium.

Still another aspect of the present invention is directed to a multi-layer information recording medium manufacturing method for manufacturing a multi-layer information recording medium including a plurality of layered information planes, comprising a first step of forming a reflective layer on a substrate formed with an information plane on one side; a second step of forming a transparent intermediate layer having an information plane on the reflective layer; a third step of forming a reflective layer on an information plane side of the intermediate layer; a fourth step of forming a transparent protective layer after the plurality of information planes are formed by repeating the second and third steps a plurality of times; and a fifth step of forming a first reflective layer, which reflects light with a specified first reflected light power when the light is incident, on at least one information plane and forming a second reflecting surface, which reflects the light with a second reflected light power smaller than the first reflected light power, on another information plane.

According to the present invention, since light can be reliably pulled in for focusing on at least one information plane coinciding with those of information recording media already on the market, lower compatibility with information recording media already on the market or of known formats can be assured and information can be recording/reproduced on/from a multi-layer information recording medium of a new format using an information recording/reproducing device already widely in use.

### BRIEF DESCRIPTION OF THE DRAWINGS

FIG. 1 is a diagram showing the construction of an optical information recording medium according to one embodiment,

FIG. 2 is a diagram showing track layouts of the respective layers of a conventional two-layer optical disc medium,

FIG. 3 is a schematic diagram showing a stack configuration of a four-layer optical disc medium according to the embodiment,

FIG. 4 is a diagram showing track layouts of the respective layers of the four-layer optical disc medium according to the embodiment,

FIG. 5 is a graph showing a relationship between a distance of each information plane from a disc outer surface and a focus error signal in the case of using a four-layer optical disc medium formed with no low reflectivity region,

FIG. 6 is a graph showing a relationship between a distance of each information plane from a disc outer surface and a focus error signal in the case of using the four-layer optical disc medium according to the embodiment,

FIG. 7 is a diagram showing the entire construction of an optical information recording/reproducing device for recording/reproducing information on/from a multi-layer optical disc medium according to the invention,

FIG. 8 is a first flow chart showing a processing procedure in a two-layer compatible optical disc device,

FIG. 9 is a second flow chart showing the processing procedure in the two-layer compatible optical disc device,

FIG. 10 is a chart showing radial area configurations of a four-layer optical disc medium according to the invention,

FIG. 11 is a chart showing radial area configurations of an eight-layer optical disc medium according to the invention,

FIG. 12 is a chart showing other radial area configurations of an eight-layer optical disc medium according to the invention,

FIG. 13 is a chart showing other radial area configurations of a four-layer optical disc medium according to the invention,

FIG. 14 is a chart showing still other radial area configurations of an eight-layer optical disc medium according to the invention,

FIG. 15 is sections showing a production method of a mold for producing a substrate used to manufacture a multi-layer optical disc medium according to the embodiment,

FIG. 16 is a section of a multi-layer optical disc medium according to the embodiment,

FIG. 17 is a diagram showing a method for manufacturing a multi-layer information recording medium according to the embodiment,

FIG. 18 is a section showing a structure of a sputterer according to the embodiment, and

FIG. 19 is a diagram showing the construction of a conventional optical disc device.

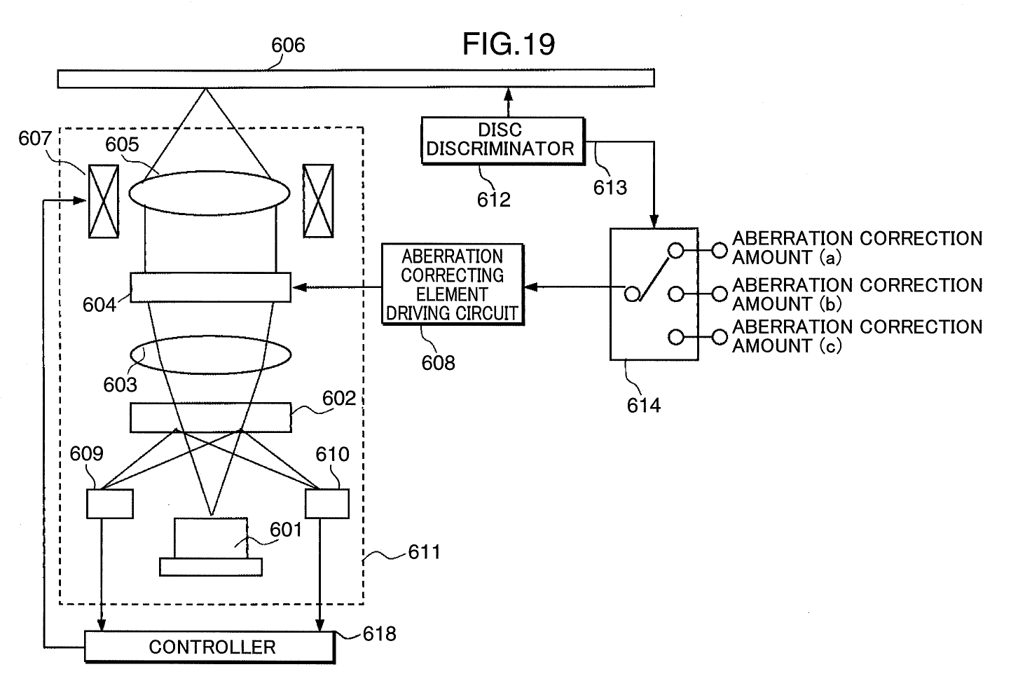

### BEST MODES FOR EMBODYING THE INVENTION

Hereinafter, a multi-layer information recording medium according to one embodiment of the present invention is described with reference to the drawings. Although a recordable phase-changing optical disc medium is described as an example of the multi-layer information recording medium in this embodiment, the multi-layer information recording medium is not particularly limited thereto. The technology of the present invention is common to multi-layer information recording mediums, on which information is recorded by forming marks having physical properties different from those unrecorded parts by injecting energy thereto (rewritable recording media such as BD-REs and recordable recording media such as BD-Rs) or optical disc media exclusive for reproduction, on which information is recorded by differences in physical shapes such as uneven pits.

A main optical condition is to use a laser having a wavelength of 405 nm and an objective lens having an NA=0.85. A disc structure is such that a track pitch is 0.32 μm and distances from a laser incident surface to information planes are 25 μm to 130 μm. A multi-layer optical disc medium, on which a signal with a shortest mark length (2T) of 0.138 μm to 0.160 μm is recorded as a mark or a pit and which has a recording capacity per layer of 23.3 GB to 27 GB is described as an example. BD 2×-speed, at which a channel rate is 132 MHz (Tw=7.58 ns) in a BD having a channel rate of 66 MHz (Tw=15.15 ns) as 1×-speed, is described as an example of a writing speed. In this case, a recording linear speed is 9.83 m/s.

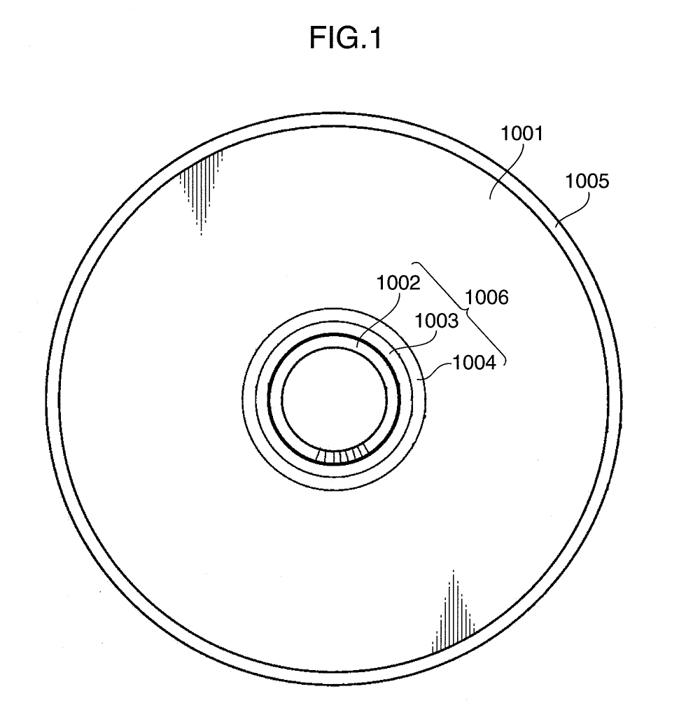

First of all, a multi-layer optical disc medium as the multi-layer information recording medium according to this embodiment is described. FIG. 1 is a diagram showing the construction of an optical information recording medium according to the embodiment. In FIG. 1 is shown an area configuration on a plane of the multi-layer optical disc medium. A read-in area 1006, a data area 1001, a read-out area 1005 are arranged from the inner circumferential side as plane areas in the optical disc medium. The read-in area 1006 includes a BCA (Burst Cutting Area) 1002, a pre-recorded area 1003, a learning area and a DMA area 1004.

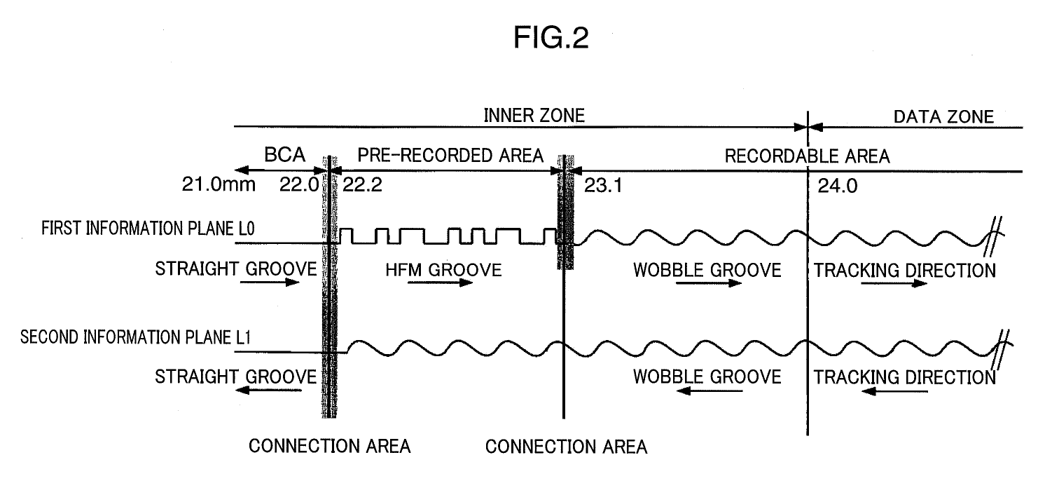

Next, track layouts of the respective layers of a conventional two-layer optical disc medium are described as a reference example. FIG. 2 is a diagram showing the track layouts of the respective layers of the conventional two-layer optical disc medium.

In FIG. 2, a read-in area is located at a side inner than about 24 mm along a radius of a first information plane L0. A BCA (Burst Cutting Area) where a unique ID peculiar to the medium is pre-recorded by burst-cutting the information plane at a position of about 21 to 22.2 mm along the radius. Recording data in the form of a barcode is formed in the BCA by forming recording marks in the form of concentric circles.

A pre-recorded area is located from 22.2 to 23.1 mm along the radius. In the pre-recorded area, recommended values of recording power and recording pulse conditions, disc information such as a recording linear speed condition, information used for copy protection and the like are recorded by wobbling a spiral groove (guide groove) called a HFM groove (pre-recorded information). These pieces of pre-recorded information are information exclusive for reproduction, which cannot be rewritten, and are recorded beforehand at the time of shipment of the disc. In other words, the BCA and the pre-recorded area are reproduction exclusive areas.

In the read-in area, the learning area for trial recording and the defect management area (DMA) are provided in a section from 23.1 to 24 mm along the radius. Trial recording is made in the learning area to calibrate variations of the recording power and recording pulse condition at the startup when the optical disc media is inserted into the optical disc device or upon a large temperature variation during the operation. The defect management area (DMA) is an area for managing defect information on the optical disc media.

The data area is provided in a section from 24.0 to 58.0 mm along the radius. The data area is an area where data a user actually wishes is written. If there is a part where information can be neither recorded nor reproduced due to a defect or the like due to PC use or the like, an ISA (Inner Spare Area) and an OSA (Outer Space Area) are set before and after a data area for recording and reproducing user data as replacement areas for replacing the part (sector, cluster) where information can be neither recorded nor reproduced. In real-time recording at a high transfer rate such as video recording/reproduction, the replacement areas are not set in some cases.

The read-out area is provided in a section from 58.0 to 58.5 mm along the radius. The read-out area is provided with a defect management area as in the read-in area and is used as a buffer area so as to permit overrun during seeking. Read-out in the sense as an end area of recording/reproduction may be located at the inner circumferential side in the case of a multi-layer optical disc media. An area outer than 23.1 mm along the radius, i.e. from the learning area to an outer zone or the read-out area is the data area (recordable area) where phase-changing marks are recorded and reproduced.

In the conventional two-layer optical disc media, an area corresponding to the BCA is provided, but the unique ID is not recorded thereon for the following reason on the information plane other than the first information plane L0 for the following reason. A signal in the form of a barcode is recorded in a radial direction in the BCA of the first information plane L0 by a recording method of burst cutting the recording layer with a high-output laser. Even if BCA information such as a unique ID is recorded anew on the second information plane L1 at this time, there is a possibility that the information cannot be reliably recorded. Conversely speaking, the reliability of the BCA of the first information plane L0 is improved by not recording the BCA information on the second information plane L1.

In the pre-recorded area, initial value information is recorded at least on the first information plane L0. The inner circumferential side of the first information plane L0 serves as an inner zone, and the outer circumferential side thereof serves as an outer zone. In this case, addresses of the first information plane L0 are recorded in an order from the inner circumferential side to the outer circumferential side, wherefore recording/reproduction is performed from the inner circumferential side to the outer circumferential side. On the second information plane L1, the inner circumferential side serves as a read-out area and the outer circumferential side serves as an outer zone. In this case, addresses of the second information plane L1 are recorded in an order from the outer circumferential side to the inner circumferential side, wherefore recording/reproduction is performed from the outer circumferential side to the inner circumferential side. By proceeding with such recording/reproduction, information can be successively recorded/reproduced from the inner circumferential side to the outer circumferential side on the first information plane L0 and from the outer circumferential side to the inner circumferential side on the second information plane L1 without necessitating full seeking from the outer circumference to the inner circumference, wherefore real-time recording at a high transfer rate such as video recording/reproduction can be performed for a long time.

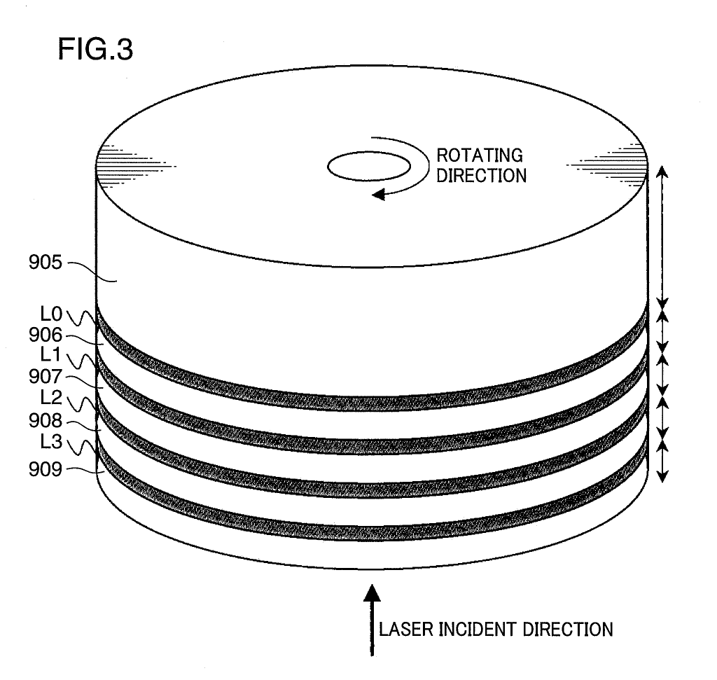

FIG. 3 is a schematic diagram showing a stack configuration of a four-layer optical disc media having four information planes from a laser incident side according to the embodiment. The four-layer optical disc media includes a substrate 905, a first information plane L0, a second information plane L1, a third information plane L2, a fourth information plane L3 and a cover layer 909. Laser light is incident on the cover layer 909. The thickness of the substrate 905 is about 1.1 mm, and that of the cover layer 909 is at least 25 μm. The respective information planes are separated by transparent space layers 906 to 908. In this embodiment, as a specific example, the thickness of the cover layer 909 is 60 μm, a thickness between the fourth and third information planes L3, L2 is 10 μm, a thickness between the third and second information planes L2, 11 is 17 μm, and a thickness between the second and first information planes L1, L0 is 13 μm, but the thickness between the respective information planes separated by the space layers may be 6 μm to 30 μm in the case of a four-layer optical disc media. The thickness between the respective information planes separated by the space layers are so optimized as to reduce the interference of diffracted lights from the respective information planes (inter-layer interference), and are not limited to the above interspace distances.

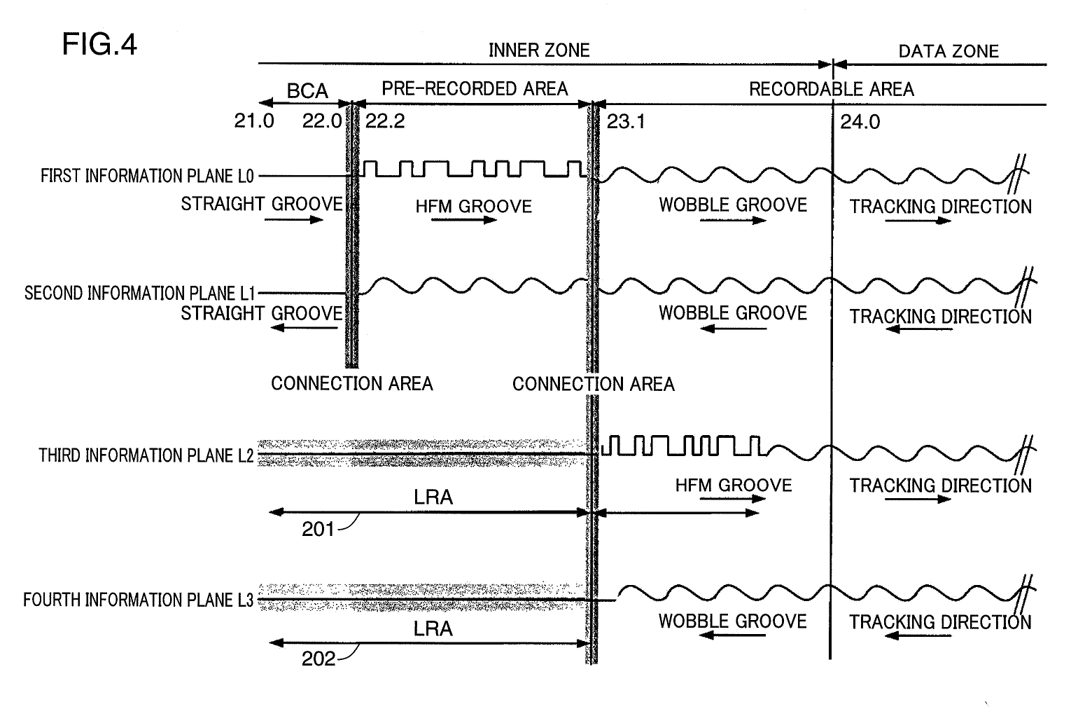

Next, track layouts of the respective layers of a four-layer optical disc media having four information planes are described. FIG. 4 is a diagram showing the track layouts of the respective layers of the four-layer optical disc media having four information planes are described.

In FIG. 4, the first information plane L0 of the four-layer optical disc medium has a track layout similar to that of the information plane of a one-layer optical disc medium having one information plane or that of the first information plane L0 of the two-layer optical disc medium having two information planes shown in FIG. 2. Similarly, the second information plane L1 of the four-layer optical disc medium has a track layout similar to that of the second information plane L1 of the two-layer optical disc medium having two information planes shown in FIG. 2. However, the read-out zone at the inner circumferential size of the second information plane L1 is an inner zone since this zone is not a recording/reproduction end in a multi-layer optical disc medium having three or more information planes.

Inner circumferential areas of the third and fourth information planes L2, L3 have track layouts different from those of the inner circumferential areas of the first and second information planes L0, L1. Normally, pre-recorded areas on the respective information planes are arranged at the same radial positions, but a pre-recorded area of the third information plane L2 is so arranged as not to largely overlap with the radial positions of the BCA and pre-recorded area of the first information plane L0 as shown in FIG. 4 in the multi-layer optical disc medium of this embodiment. This is designed to reduce a reduction in reproduced signal quality due to scattering and diffraction of a light beam passing the fourth and third information planes L3, L2 upon the reproduction from the BCA and pre-recorded area of the first information plane L0.

On the third information plane L2, a HFM groove formed by the wobbling of a track corresponding to the pre-recorded area starts at a position of 23.1 mm along the radius and ends at a position of 24.0 mm where a user data area starts. A learning area and a DMA area are arranged outside the pre-recorded area. Similarly, on the fourth information plane L3, a learning area and a DMA area are arranged outside a position of 23.1 mm along the radius. In the four-layer optical disc medium, the BCA is not recorded on any information planes other than the first information plane L0.

The pre-recorded area is provided on the first information planes L0 and at least one of the third and fourth information planes L2 and L3, and disc management information is recorded on a total of at least two places in the entire recording medium. Information such as recording powers, recording pulse conditions, disc versions and layer numbers of the first and second information planes L0, L1 are recorded in the pre-recorded area of the first information plane L0, and the disc management information of the third and fourth information planes L2, L3 is recorded in a specified area of a management area, which has not been conventionally used as a reserve area. By doing so, it is possible not only to read the disc management information by a conventional optical disc device, but also to collectively read the disc management information of all the information planes from the first to fourth information planes L0 to L3 in an optical disc device for a new multi-layer optical disc medium, wherefore a start time can be shortened.

Information such as the recording powers and recording pulse conditions at least relating to the third and fourth information planes L2, L3 is recorded on the third information plane L2. A recording space of the third information plane L2 can be saved by deleting information such as the recording powers and recording pulse conditions relating to the first and second information planes L0, L1, which information is recorded in conventional two-layer optical disc media, from the third information plane L2.

Flag information indicating as to whether or not recording in the user data areas of the third and fourth information planes L2, L3 is possible is recorded in a recordable area in the inner zone of the third information plane L2. If the flag information indicates a recording impossible state on the third and fourth information planes L2, L3, data cannot be recorded on the third and fourth information planes L2, L3 and is recorded only on the first and second information planes L0, L1. Although the flag information cannot be read by a conventional drive compatible with two-layer optical disc media, it can be read, written or rewritten in a four-layer compatible optical disc device. The four-layer compatible optical disc device can record data on the four-layer optical disc medium using this flag information so that data can be read by a two-layer compatible optical disc device. In other words, the four-layer compatible optical disc device enables data readout using two-layer compatible optical disc devices already and widely available on the market by recording data in the same format only in the same area of four-layer optical disc media as two-layer optical disc media.

The four-layer compatible optical disc device can also set the flag information to a state of prohibiting the recording of data on the third and fourth information planes L2, L3, and set the flag information to a state of permitting the recording of data on the third and fourth information planes L2, L3 after data are recorded in the same areas of the two-layer optical disc medium, thereby recording data on the entire four-layer optical disc medium. By doing so, a user commonly uses one optical disc medium between the two-layer compatible optical disc device and the four-layer compatible optical disc device, wherefore data can be freely transferred.

Besides forming a track having a spiral groove in the parts of the third and fourth information planes L2, L3 inner than 23.1 mm, a mirror surface may be formed without forming any groove. By forming the areas corresponding to the pre-recorded areas and BCAs of the third and fourth information planes L2, L3 into mirror surfaces in this way, diffracted lights caused by the grooves are reduced to make it easier to pull in light for focusing on the first and second information planes L0, L1.

In FIG. 4, areas 201, 202 are respectively low reflectivity areas (LRAs) at the inner circumferential areas of the third and fourth information planes L2, L3, and the laser light is more efficiently collected to the first and second information planes L0, L1 by maximally reducing the reflection and scattering of the laser light in these areas. The low reflectivity areas are designed on the condition of having a reflectivity of about 0 or having a large difference in reflectivity from those of the other areas. For example, if R denotes a reflectivity ratio which is a ratio of a reflected light power to a laser emitted light, the range of the reflectivity ratio Rd in the low reflectivity areas is designed to be 0≦Rd<3.5% and the range of the reflectivity ratio Rb in the other areas is 3.5≦Rb≦8%. Alternatively, a relationship between the reflectivity ratio Rd in the low reflectivity areas and that Rb in the other areas may be designed to be 2×Rd<Rd.

Reflectivity from the disc outer surface (thickness of 0 μm) is theoretically about 4%, and the reflectivity ratio Rd is set to a reflected light level below this surface reflectivity. When laser light is incident on an optical disc surface, it is focused on an information plane through a cover layer. A refractive index N of this cover layer resin is about 1.5±0.1. Generally, reflectivity from the surface when light is vertically incident on a medium from the air is expressed by R=(1−n)²/(1+n)² if the refractive index of the medium is n. Thus, the reflectivity from the cover layer resin surface is calculated to be 3% to 5%. However, if an optical system is aberration-corrected in an information plane having an incident thickness of 100 μm as in the multi-layer optical disc medium according to this embodiment, a reflected light power from the surface is attenuated to about 70% due to spherical aberration corresponding to the thickness of the cover layer on the disc surface. A value obtained by multiplying the surface reflectivity by an attenuation amount of the spherical aberration is an actual reflected light power from the surface, and the surface reflectivity is about 2% to 3.5%.

Since the value of the refractive index of the cover layer resin is predetermined, the surface reflectivity of about 3% is stored beforehand in the optical disc device. If the reflected light power from the low reflectivity area is smaller than an amplitude value of an RF signal generated by the surface reflection, there is a lower possibility of erroneously detecting that such a reflected light is the one from the disc outer surface. Accordingly, the reflectivity of the low reflectivity area is desired to be smaller than the reflected light from the outer surface (surface reflection).

In order to reliably detect an S-shaped waveform from the surface, it is a most reliable method to detect it while using half the S-shaped waveform as a slice level. Accordingly, it is most effective to set the reflectivity ratio Rd in the low reflectivity area equal to or below half the surface reflectivity. By designing the reflectivity ratio Rd in the low reflectivity area to be smaller than a reflected light power smaller than the value stored in the information recording/reproducing device, the multi-layer information recording media can be utilized in two-layer compatible information recording/reproducing devices.

By reducing reflected lights and scattered lights from the third and fourth information planes L2, L3, it can be made easier to pull in light for focusing on the first and second information planes L0, L1 at the time of starting the disc. As a sequence at the time of inserting the disc or starting the optical disc device, the BCA in the inner circumferential area of the first information plane L0 is reproduced. This is because a processing of pulling in the laser light for focusing is generally performed in the inner circumferential area having BCA. The areas 201, 202 of the third and fourth information planes L2, L3 located at the radial position including the BCA of the first information plane L0 are set to have lower reflectivity as compared with areas of the first and second information planes L0, L1 at the same radial position, thereby reducing reflected lights from the third and fourth information planes L2, L3. Thus, the laser light can be reliably pulled in for focusing on the BCA of the first information plane L0.

In this embodiment, the BCAs and the pre-recorded areas of the first and second information planes correspond to a first reflecting surface, and the low reflectivity areas of the third and fourth information planes correspond to a second reflecting surface.

Methods for forming the low reflectivity areas (LRAs) in the inner circumferential areas of the above third and fourth information planes L2, L3 include a method for realizing a low reflecting state by irradiating the recording layers of the third and fourth information planes L2, L3 with laser light of a recording power by a laser initializer and forcibly forming marks beforehand to perform pre-recording after the information planes are formed in the disc manufacturing process before the shipment of the disc. There may be adopted a method for performing pre-recording with a recording power to form marks not only by using the laser initializer, but also by reducing the irradiation power of a BCA writer. In the case of using these methods, optical disc media can be produced by a normal film forming process and can be easily produced in large quantities without necessitating a special facility for the disc manufacturing process.

Another method is such as to form low reflectivity areas by burning out reflective layers of desired information planes using a focused beam of a high-output laser provided in a BCA writer or the like. Still another method is such as to form no reflective layers in the inner circumferential areas by masking the low reflectivity areas in the inner circumferential areas, for example, upon forming reflective layers using a sputterer. In this case, since the low reflectivity areas can be easily formed by changing the sizes of the masks, a step of pre-recording by laser light and a step of burst-cutting reflective layers to form low reflectivity areas become unnecessary after the manufacturing of the disc, wherefore a conventional disc manufacturing process can be used as it is.

In this embodiment, out of the plurality of information planes, the reflectivities of the inner circumferential areas (BCAs and pre-recorded areas) of the information planes compatible with conventional optical disc media, e.g. two-layer optical disc media are set higher than those of the inner circumferential areas of the other information planes. However, the present invention is not particularly limited thereto, and the reflectivities of the data areas on the information planes other than those compatible with conventional optical disc media may be set lower than those of the compatible information planes. For example, the reflectivities of the data areas of the third and fourth information planes L2, L3 are set lower than those of the data areas of the first and second information planes L0, L1. In this case, the reflectivities in the entire areas of the third and fourth information planes L2, L3 including the inner circumferential areas, the data areas and the like may be set lower than those of the entire areas of the first and second information planes L0, L1. It should be noted that the BCAs, pre-recorded areas and data areas of the first and second information planes correspond to the first reflecting surface and the low reflectivity areas and data areas of the third and fourth information planes correspond to the second reflecting surface in this case.

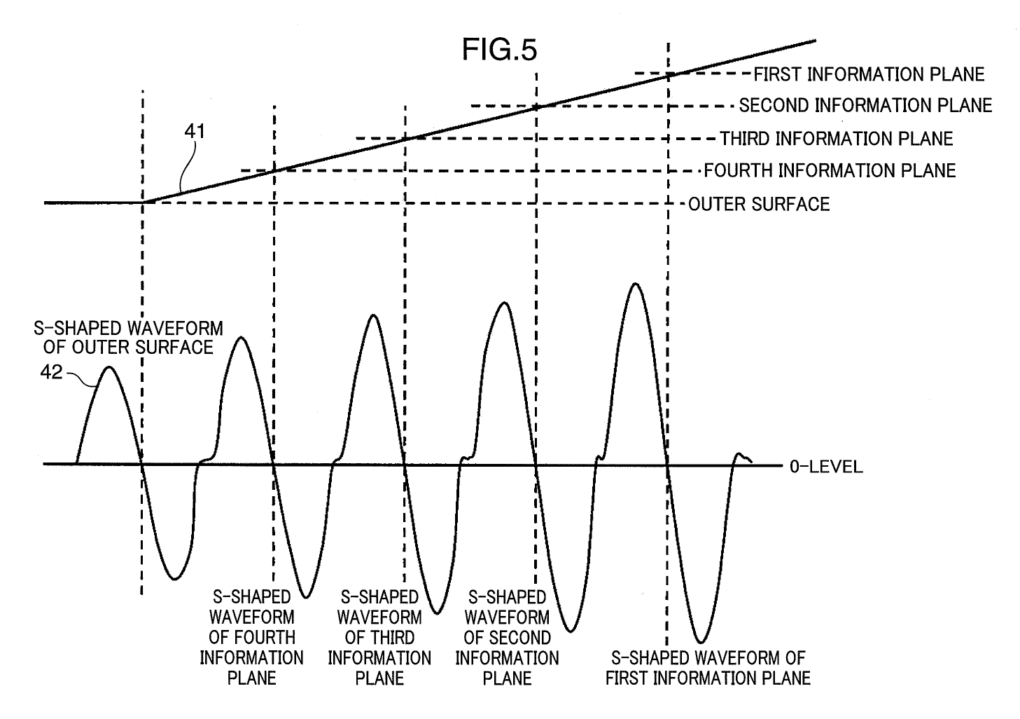

Next, an operation at the time of pulling in light for focusing on the information plane of the multi-layer optical disc medium is described. In the case of using an astigmatism method for a focus error signal, light is pulled in for focusing an S-shaped characteristic of the focus error signal. FIG. 5 is a graph showing distances of information planes from a disc outer surface and a focus error signal in the case of using a four-layer optical disc medium formed with no low reflectivity areas. A straight line 41 of FIG. 5 represents that the focal point of laser light gradually moves from the disc outer surface toward the information planes located at more backward positions from the left side toward the right side of the plane of FIG. 5. At this time, S-shaped waveforms 42 as shown in FIG. 5 appear in the focus error signal according to reflecting surfaces (information planes) of the optical disc medium.

If the thickness of the disc incident surface is optimized to the first information plane L0 by a spherical aberration correcting section, the amplitudes of the S-shaped waveforms gradually increase in an order of the S-shaped waveform of the disc outer surface, that of the fourth information plane L3, that of the third information plane L2, that of the second information plane L1 and that of the first information plane L0. These five S-shaped waveforms 42 appear as the focus error signal. If an attempt is made to pull in light for focusing on such a four-layer optical disc medium, for example, in a two-layer compatible optical disc device already on the market, more S-shaped signals than assumed are detected and it becomes difficult to accurately pull in light for focusing on a desired information plane. Accordingly, in this embodiment, the low reflectivity areas are provided at positions of the third and fourth information planes L2, L3 for detecting the focus error signal as described above.

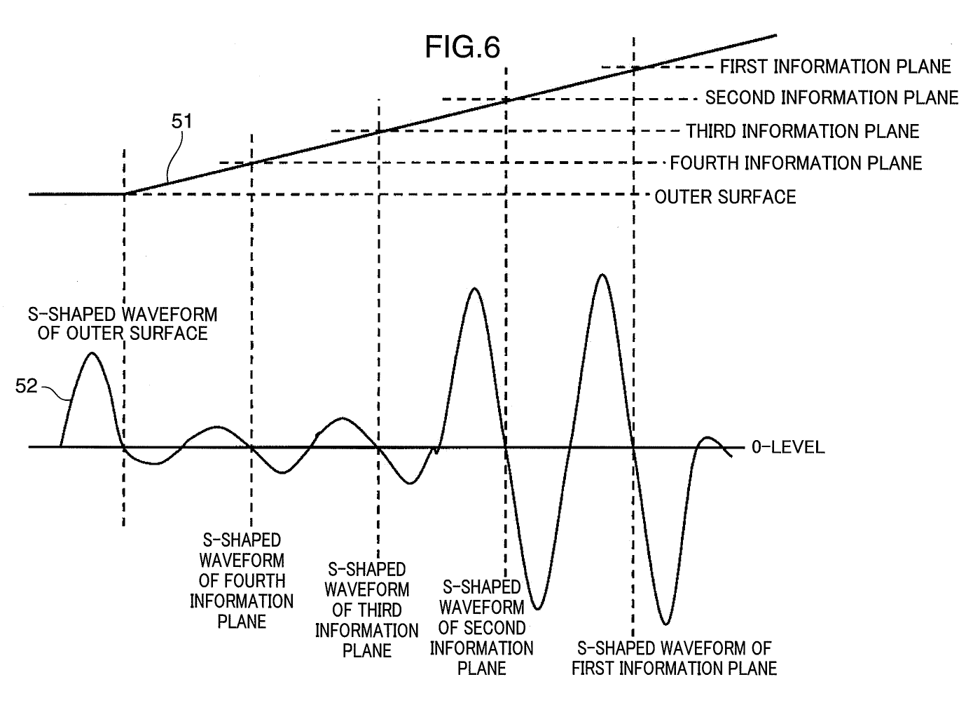

FIG. 6 is a graph showing distances of information planes from a disc outer surface and a focus error signal in the case of using a four-layer optical disc medium according to this embodiment. A straight line 51 of FIG. 6 represents a change of the focus position of a laser beam spot from a disc outer surface, and S-shaped waveforms 52 represent the focus error signal. The straight line 51 represents that the focal point of the laser light gradually moves from the disc outer surface toward the information planes located at more backward positions from the left side toward the right side of the plane of FIG. 6. At this time, the S-shaped waveforms 52 as shown in FIG. 6 appear in the focus error signal according to reflecting surfaces (information planes) of the optical disc medium.

If the disc thickness is optimized to the first information plane L0 by the spherical aberration correcting section, three S-shaped waveforms 52 shown in FIG. 6 appear. The S-shaped waveform of the disc outer surface, that of the second information plane L1 and that of the first information plane L0 successively appear in a laser incident direction. In the four-layer optical disc medium formed with low reflectivity areas, these three S-shaped waveforms appear as the focus error signal. These are S-shaped waveforms substantially similar to those of the two-layer optical disc medium having two information planes. Thus, in the case of using a two-layer compatible optical disc medium already on the market, focusing can be performed as if this optical disk medium were a two-layer optical disk medium and it becomes possible to easily pull in light for focusing on the first information plane L0 and to reproduce the BCA.

Although the multi-layer optical disc medium is described, taking the four-layer optical disc medium having four layers of information planes as an example in the above embodiment, it goes without saying that application to multi-layer optical disc media having five or more layers including low reflectivity areas is also possible.

Further, although the track layouts of the four-layer optical disc medium including the track layouts of the two-layer optical disc medium are described as an example in this embodiment, the multi-layer information recording medium may be a three-layer optical disc medium including a track layout of a one-layer optical disc medium. In this case, the track layout of a first information plane L0 of the three-layer optical disc medium is the same as that of the one-layer optical disc medium and the track layouts of second and third information planes L1, L2 of the three-layer optical disc medium include low reflectivity areas in the inner circumferential areas thereof.

The multi-layer information recording medium may be a three-layer optical disc medium including track layouts of a two-layer optical disc medium. In this case, the track layouts of first and second information planes L0, L1 of the three-layer optical disc medium are the same as those of first and second information planes L0, L1 of the two-layer optical disc medium, and a third information plane L2 of the three-layer optical disc medium has a track layout including a low reflectivity area in the inner circumferential area thereof.

Furthermore, the multi-layer information recording medium may be a two-layer optical disc medium including track layouts of a one-layer optical disc medium. In this case, the track layouts of a first and second information plane L0 is the same as that of a first information plane L0 of the one-layer optical disc medium, and a second information plane L1 of the two-layer optical disc medium has a track layout including a low reflectivity area in the inner circumferential area thereof. At this time, the reflectivity in the inner circumferential area is lower than that of a data area for recording data.

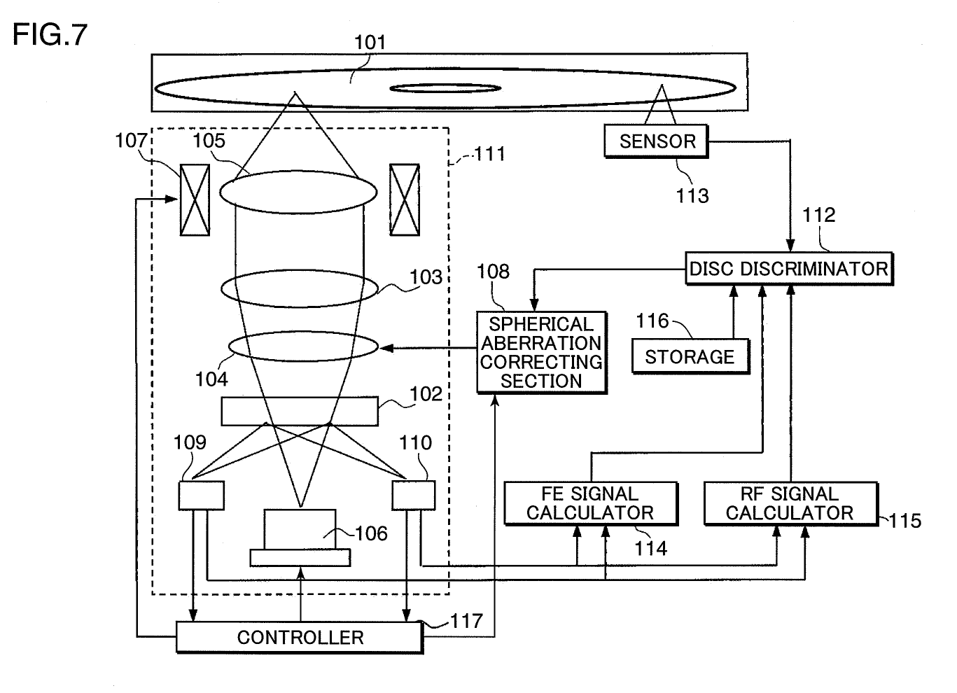

Next, an information recording/reproducing system on/from the four-layer optical disc medium according to this embodiment is described. FIG. 7 is a diagram showing an exemplary overall construction of an information recording/reproducing device (optical disc device) for recording/reproducing information on/from the multi-layer optical disc medium according to this embodiment.

In FIG. 7, the optical disc device is provided with a spherical aberration correcting section 108, an optical pickup 111, a disc discriminator 112, a sensor 113, a FE (focus error) signal calculator 114, an RF signal calculator 115, a storage 116 and a controller 117. The optical pickup 111 includes a diffraction element 102, collimator lenses 103, 104, an objective lens 105, a laser light source 106, an actuator 107 and optical detectors 109, 110.

Here, the operation of the optical disc device shown in FIG. 7 is described. First of all, the laser light source 106 emits a light beam. The light beam emitted from the laser light source 106 passes through the diffraction element 102 and is converted into a parallel light by the collimator lenses 103, 104 to be incident on the objective lens 105. The objective lens 105 focuses the light beam on an information recording surface of a multi-layer optical disc medium 101. The light beam reflected by the multi-layer optical disc medium 101 propagates backward along an original optical path to be focused by the collimator lenses 103, 104 and is branched by the diffraction element 102 to be incident on the optical detectors 109, 110. A servo signal including a focus error signal and a tracking error signal and an information signal (RF signal) are generated from output signals of the optical detectors 109, 110.

Here, NA of the objective lens 105 is equal to or larger than 0.8. The actuator 107 performs a focus control as a position control of the objective lens 105 in an optical axis direction and a tracking control as a position control of the objective lens 105 in a direction perpendicular to an optical axis in accordance with signals from the controller 117. The actuator 107 is driving means including a coil or a magnet. Further, the FE signal calculator 114 generates an FE signal based on the signals from the optical detectors 109, 110, and the RF signal calculator generates an RF signal based on the signals from the optical detectors 109, 110.

The sensor 113 detects a hole of a disc cartridge and outputs a detection signal. The disc discriminator 112 discriminates the type of the multi-layer optical disc medium 101 using disc discrimination information obtained from any one of an FE amplitude FE0 and an RF amplitude RF0 stored in the storage 116, an FE amplitude FE1 and an RF amplitude RF1 generated by the FE signal calculator 114 and the RF signal calculator 115 and the detection signal from the sensor 113 or a combination of a plurality of these signals. The spherical aberration correcting section 108 drives the collimator lens 104 according to the type of the optical disc medium discriminated by the disc discriminator 112 and makes an optimal spherical aberration correction according to a distance of each information plane from the outer surface.

The controller 117 sets a write-prohibit flag for prohibiting data recording in the user data area for each information plane and also prohibits data recording on the information plane for which the write-prohibit flag is set. In this embodiment, this laser light source 106 corresponds to an example of a laser light emitter, the spherical aberration correcting section 108 to an example of a spherical aberration correcting section, the controller 117 to examples of a controller, a flag setting section and a recording prohibiting section and the disc discriminator 112 to an example of a medium discriminator.

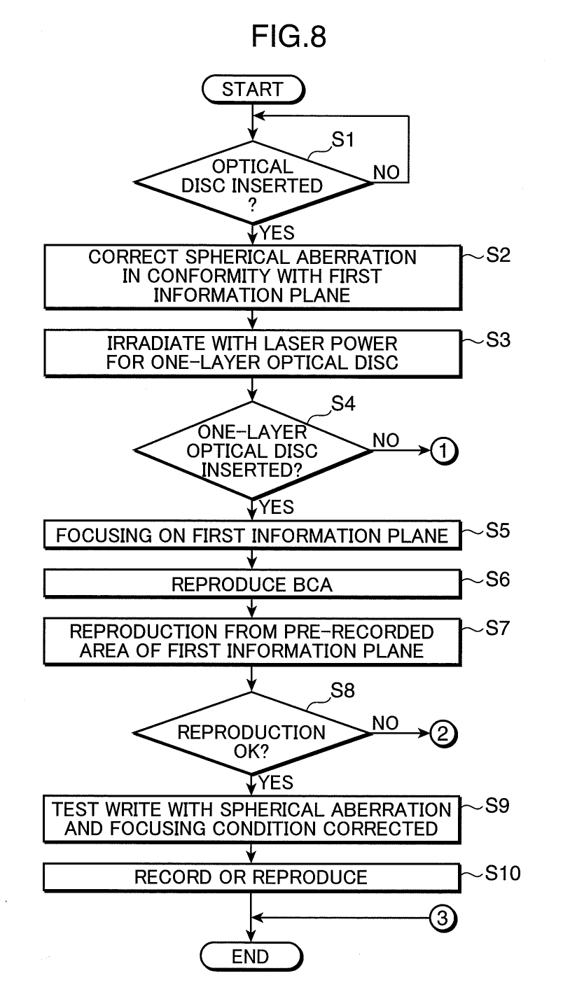

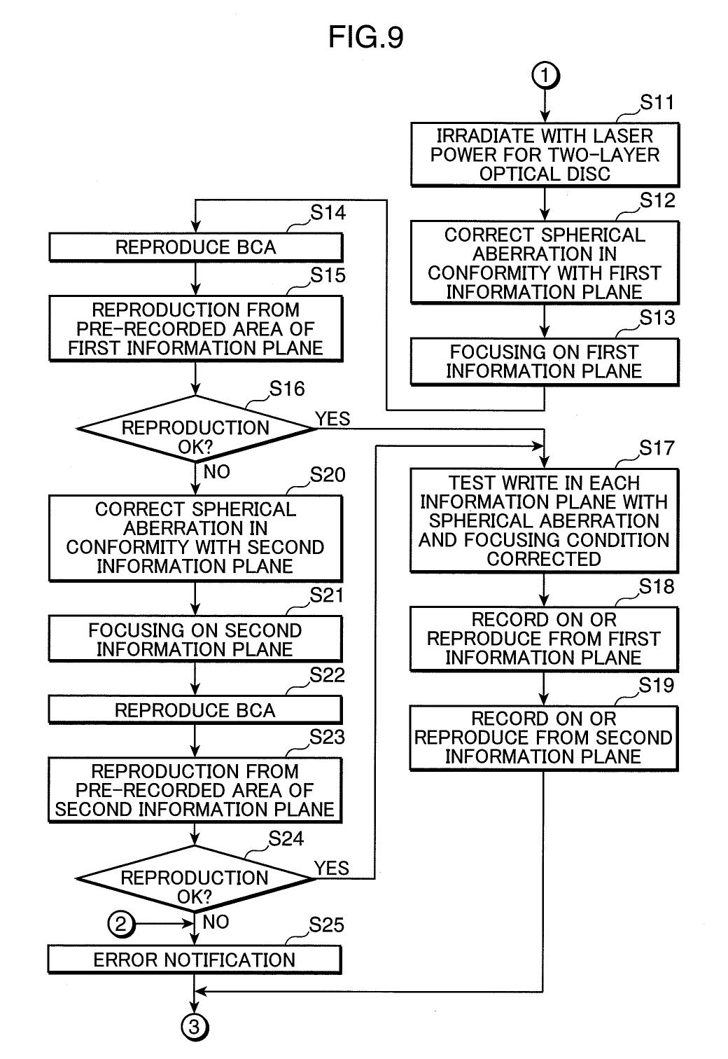

A processing procedure in a two-layer compatible optical disc device upon loading the multi-layer optical disc medium 101 according to this embodiment is described. FIGS. 8 and 9 are flow charts showing the processing procedure in the two-layer compatible optical disc device.

First, in Step S1, the controller 117 judges whether or not the multi-layer optical disc medium 101 has been inserted into the optical disc device. Here, if it is judged that no optical disc medium has been inserted (NO in Step S1), a judgment processing of Step S1 is performed at specified time intervals until the optical disc medium is inserted.

On the other hand, if the multi-layer optical disc medium 101 was loaded into the two-layer compatible optical disc device and the insertion of the optical disc medium was judged (YES in Step S1), the controller 117 instructs the spherical aberration correcting section 108 to correct a spherical aberration in conformity with the first information plane L0 of the multi-layer optical disc medium 101 in Step S2. The spherical aberration correcting section 108 corrects the spherical aberration in conformity with the first information plane L0 by driving the collimator lens 104. The collimator lens 104 has a function of changing the diameter of the laser light in the optical system as shown in FIG. 7. Specifically, the diameter of the laser light emitted to the multi-layer optical disc medium 101 is adjusted by moving the collimator lens 104 in the optical axis direction. In other words, the optical disc device can perform an optimal spherical aberration correction for the first information plane L0 by including the spherical aberration correcting section 108 for moving the collimator lens 104 in the optical axis direction instead of including an aberration correcting element such as a liquid crystal.

Besides such a spherical aberration correction method, it is also possible to adopt a method for correcting a spherical aberration by including a liquid crystal panel or the like instead of the collimator lenses 103, 104. However, the spherical aberration correction method of this embodiment obviates the need for the liquid crystal panel or the like and is better in light of reducing the number of parts of the optical disc device, saving cost and adjustment steps and promoting miniaturization.

Subsequently, in Step S3, the controller 117 controls the laser light source 106 to emit laser light with a power set for the one-layer optical disc medium. Generally, a reflected light power from a one-layer optical disc medium is about four times as much as a reflected light power of a two-layer optical disc medium if the transmissivity of a second information plane L1 is 50%, and the controller 117 sets the laser power lower than that for the two-layer optical disc medium. The controller 117 also sets the power of laser light emitted at the time of reading to about ½ of the laser power for the two-layer optical disc medium so as not to erroneously delete marks recorded with high emission power.

Subsequently, in Step S4, the disc discriminator 112 discriminates the type of the optical disc medium to judge whether or not it is a one-layer optical disc medium. Here, a method for discriminating the type of the optical disc medium by the disc discriminator 112 is described.

A first disc type discrimination method is for discriminating using a cartridge in which the optical disc medium is contained. First of all, the sensor 113 of FIG. 7 emits infrared ray or light of another wavelength toward the cartridge. The disc discriminator 112 discriminates whether or not the inserted optical disc medium is contained in the cartridge based on information from a reflected light by the optical disc medium. If the optical disc medium is contained in the cartridge, the disc discriminator 112 discriminates the type of the optical disc medium using a sensor hole formed in the cartridge. It should be noted that the disc discriminator 112 discriminates whether the optical disc medium is a two-layer optical disc medium, a one-layer optical disc medium, a ROM optical disc medium, a rewritable optical disc medium or a recordable optical disc medium.

A second disc type discrimination method is for discriminating based on reflected light from the optical disc medium if the optical disc medium is not contained in a cartridge. The disc discriminator 112 discriminates whether the optical disc medium is a one-layer optical disc medium or a two-layer optical disc medium based on the signal level of the RF signal generated by the RF signal calculator 115 of FIG. 7 and the amplitude level of the FE signal generated by the FE signal calculator 114. Whether or not the optical disc medium is a one-layer optical disc medium or a two-layer optical disc medium is discriminated based on a difference in the reflected light power from the optical disc medium. The disc discriminator 112 makes discrimination by comparing the signal level of the RF signal and the amplitude level of the FE signal generated from actual reflected light from the optical disc medium with a reference signal level of the RF signal and a reference amplitude level of the FE signal stored beforehand in the storage 116. An optical disc medium belonging to none of groups in an initially set range, e.g. the one with a reflected light power of 0 or exceeding a limit is judged as an abnormal disc and an error processing is performed.

A third disc type discrimination method is for discriminating using the number of S-shaped waveforms of a focus error signal. S-shaped waveforms as shown in FIG. 5 or 6 appear in a focus error signal by gradually moving the focal position of the laser light from the disc outer surface in the thickness direction of the optical disc medium with a focus servo turned off. The disc discriminator 112 discriminates whether or not the optical disc medium is a one-layer optical disc medium or a two-layer optical disc medium by counting the number of S-shaped waveforms whose threshold amplitudes exceed a predetermined value.

As described above, in this embodiment, the type of the optical disc medium is discriminated using the reflected light power from the optical disc medium, the S-shaped waveforms of the FE signal or the signal level of the FR signal. According to these disc type discrimination methods, the type of the optical disc medium can be discriminated before the laser light is pulled in for focusing. Thus, the type of the optical disc medium can be discriminated without erroneously deleting recorded marks already written on the optical disc medium or erroneously recording by light emission with the recording power. Since the type of the optical disc medium can be discriminated before the BCA and the management information recorded beforehand on the optical disc medium are read, time required for disc discrimination can be shortened and a start time can be accelerated.

Next, an operation when the optical disc medium is discriminated to be a one-layer optical disc medium by the disc discriminator 112 is described. If the optical disc medium is discriminated to be a one-layer optical disc medium (YES in Step S4), Step S5 follows.

After performing a spherical aberration correction corresponding to the first information plane L0, the controller 117 moves the objective lens 105 by driving the actuator 107 to focus the laser light on the first information plane L0 in Step S5. Subsequently, in Step S6, the controller 117 causes the optical pickup 111 to access to the BCA 1002 in the inner circumferential area of the optical disc medium and to read the unique ID recorded in the BCA 1002.

Subsequently, in Step S7, the controller 117 causes the optical pickup 111 to access to the pre-recorded area 1003 and to read the management information in the pre-recorded area 1003. Subsequently, in Step S8, the controller 117 judges whether or not the management information in the pre-recorded area could be reproduced. Here, if it is judged that the management information could be reproduced (YES in Step S8), the controller 117 successively performs trial recording (test write) using the learning area 1004 (test write area) on each information plane according to the type of the optical disc medium to calibrate the laser power and the recording pulse condition in Step S9. In other words, in the case of the one-layer optical disc medium, the controller 117 performs a test write in the learning area 1004 of the first information plane L0.

After the test write, the controller 117 performs a recording or reproducing operation in Step S10. The controller 117 records or reproduces information while performing the spherical aberration correction and the focus control.

Next, an operation when the optical disc medium is discriminated to be a two-layer optical disc medium by the disc discriminator 112 is described. If the optical disc medium is discriminated to be not a one-layer optical disc medium, in other words, if the optical disc medium is discriminated to be a two-layer optical disc medium (NO in Step S4), Step S11 of FIG. 9 follows.

In Step S11, the controller 117 controls the laser light source 106 to emit laser light with a power set for the two-layer optical disc medium. Subsequently, in Step S12, the controller 117 instructs the spherical aberration correcting section 108 to correct a spherical aberration in conformity with the first information plane L0 of the multi-layer optical disc medium 101. The spherical aberration correcting section 108 corrects the spherical aberration in conformity with the first information plane L0 by driving the collimator lens 104.

After performing a spherical aberration correction corresponding to the first information plane L0, the controller 117 moves the objective lens 105 by driving the actuator 107 to focus the laser light on the first information plane L0 in Step S13. Subsequently, in Step S14, the controller 117 causes the optical pickup 111 to access to the BCA 1002 of the first information plane L0 and to read the unique ID recorded in the BCA 1002.

Subsequently, in Step S15, the controller 117 causes the optical pickup to access to the pre-recorded area 1003 of the first information plane L0 and to read the management information in the pre-recorded area 1003. Subsequently, in Step S16, the controller 117 judges whether or not the management information in the pre-recorded area 1003 of the first information plane L0 could be reproduced. Here, if it is judged that the management information could be reproduced from the information plane L0 (YES in Step S16), the controller 117 successively performs trial recording (test write) using the learning area 1004 (test write area) on each information plane to calibrate the laser power and the recording pulse condition in Step S17.

Specifically, the controller 117 performs a test write in the learning area 1004 of each of the first and second information planes L0, L1 to set an optimal laser power for each information plane. Here, every time a test write is performed on the information plane, a spherical aberration correction and a focus control are performed for the information plane, for which the test write is performed, if necessary.

Subsequently, in Step S18, the controller 117 records or reproduces information on or from the first information plane L0 while performing the spherical aberration correction and the focus control. Subsequently, in Step S19, the controller 117 records or reproduces information on or from the second information plane L1 while performing the spherical aberration correction and the focus control.

Here, the management information needs to be read from the pre-recorded area before actually recording or reproducing data. It is good if the management information on the both information planes can be read from the pre-recorded area of the first information plane L0, but no information can be recorded on or reproduced from this optical disc medium if the management information could not be read for a certain reason.

As described above, in the case of the two-layer optical disc medium, the same management information as that in the pre-recorded area of the first information plane L0 is recorded also in the pre-recorded area of the second information plane L1. Accordingly, in this embodiment, the management information may be read from another information plane if it could not be read from the first information plane L0.

Specifically, if it is judged that the management information could not be reproduced from the first information plane L0 (NO in Step S16), the controller 117 instructs the spherical aberration correcting section 108 to correct a spherical aberration in conformity with the second information plane L1 of the multi-layer optical disc medium 101 in Step S20. The spherical aberration correcting section 108 corrects the spherical aberration in conformity with the second information plane L1 by driving the collimator lens 104.

Subsequently, in Step S21, the controller 117 moves the objective lens 105 by driving the actuator 107 to focus the laser light on the second information plane L1. Subsequently, in Step S22, the controller 117 causes the optical pickup 111 to access to the BCA 1002 of the second information plane L1 and to read the unique ID recorded in the BCA 1002.

Subsequently, in Step S23, the controller 117 causes the optical pickup to access to the pre-recorded area 1003 of the second information plane L1 and to read the management information in the pre-recorded area 1003. Subsequently, in Step S24, the controller 117 judges whether or not the management information in the pre-recorded area 1003 of the second information plane L1 could be reproduced. Here, if it is judged that the management information could be reproduced from the second information plane L1 (YES in Step S24), Step S17 follows.

On the other hand, if it is judged that the management information could not be reproduced from the second information plane L1 (NO in Step S24), the controller 117 makes an error notification to end the processing in Step S25. Specifically, information can be neither recorded on nor reproduced from the optical disc medium if the management information can be read from neither of the first and second information planes L0, L1. If it is judged that the management information cannot be reproduced from the first information plane L0 in Step S8 (NO in Step S8), Step S25 follows.

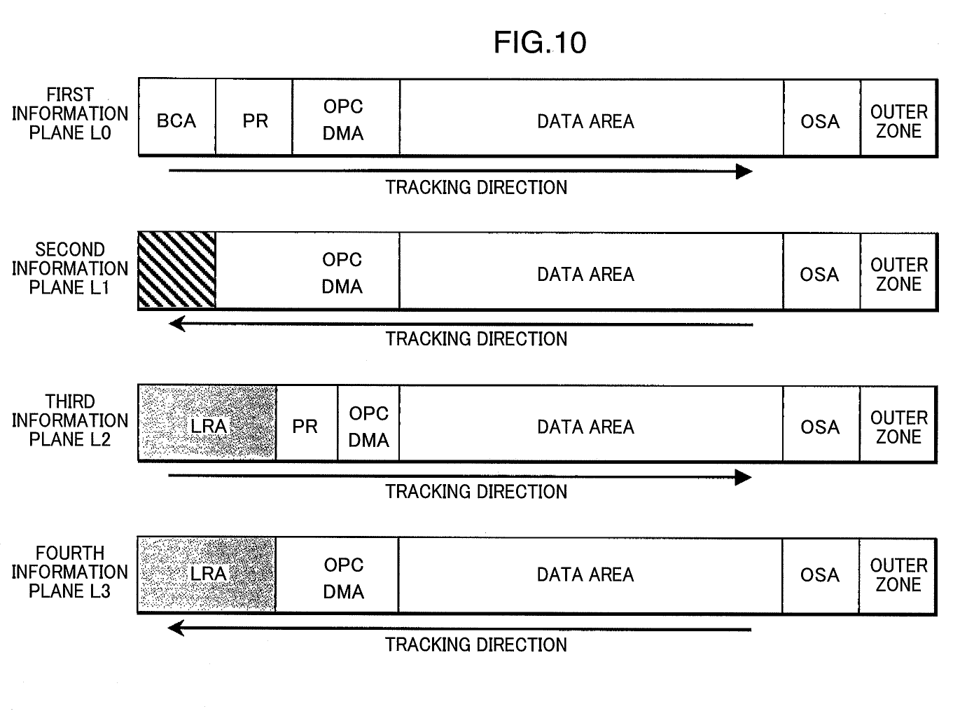

Next, area configurations of a four-layer optical disc medium and an eight-layer optical disc medium according to this embodiment are described. FIG. 10 is a chart showing a radial area configuration of the four-layer optical disc medium corresponding to the track layouts shown in FIG. 4. It should be noted that the arrangement of the BCA, the pre-recorded areas (PRs), the learning areas and the DMAs (OPCs, DMAs), the data areas and the read-out area are as described with reference to FIGS. 1 and 4.

In the four-layer optical disc medium, the first information plane L0 has an area configuration similar to that of the one-layer optical disc medium or the first information plane L0 of the two-layer optical disc medium. However, a part corresponding to the read-out zone in the one-layer optical disc medium is not a recording/reproduction end in the four-layer optical disc medium and, hence, becomes an outer zone. The second information plane L1 of the four-layer optical disc medium has an area configuration similar to that of the second information plane L1 of the two-layer optical disc medium. However, the read-out zone at the inner circumferential side of the second information plane L1 of the two-layer optical disc medium is not a recording/reproduction end in the four-layer optical disc medium and, hence, becomes an inner zone.

On the third information plane L2, a low reflectivity area (LRA), a pre-recorded area (PR), a learning area and a DMA area (OPC, DMA) are arranged in an inner circumferential area, an inner circumferential side serves as an inner zone and an outer circumferential side serves as an outer zone. In this case, addresses of the third information plane L2 are recorded in an order from the inner circumferential side to the outer circumferential side, wherefore recording/reproduction is performed from the inner circumferential side to the outer circumferential side.

On the fourth information plane L3, a low reflectivity area (LRA), a learning area and a DMA area (OPC, DMA) are arranged in an inner circumferential area, an inner circumferential side serves as a read-out zone and an outer circumferential side serves as an outer zone. In this case, addresses of the fourth information plane L3 are recorded in an order from the outer circumferential side to the inner circumferential side, wherefore recording/reproduction is performed from the outer circumferential side to the inner circumferential side. By proceeding with such recording/reproduction, as in the case of the above two-layer optical disc medium, information can be successively recorded/reproduced from the inner circumferential side to the outer circumferential side of the first information plane L0, from the outer circumferential side to the inner circumferential side of the second information plane L1, from the inner circumferential side to the outer circumferential side of the third information plane L2 and from the outer circumferential side to the inner circumferential side of the fourth information plane L3 without requiring full seeking from the outer circumference to the inner circumference, wherefore real-time recording at a high transfer rate such as video recording/reproduction can be performed for a long time.

The addresses are counted up from the inner circumferential side to the outer circumferential side on the first and third information planes L0, L2 while being counted up from the outer circumferential side to the inner circumferential side on the second and fourth information planes L1, L3. By using complements of the addresses of the odd-numbered information planes (first and third information planes) on the even-numbered information planes (second and fourth information planes), in-layer addresses can be expressed by bit numbers of in-layer addresses of one information plane. Further, since relationships between the addresses of the first and second information planes L0, L1 and the third and fourth information planes L2, L3 and the radial positions can also be known, a high-speed access is possible.

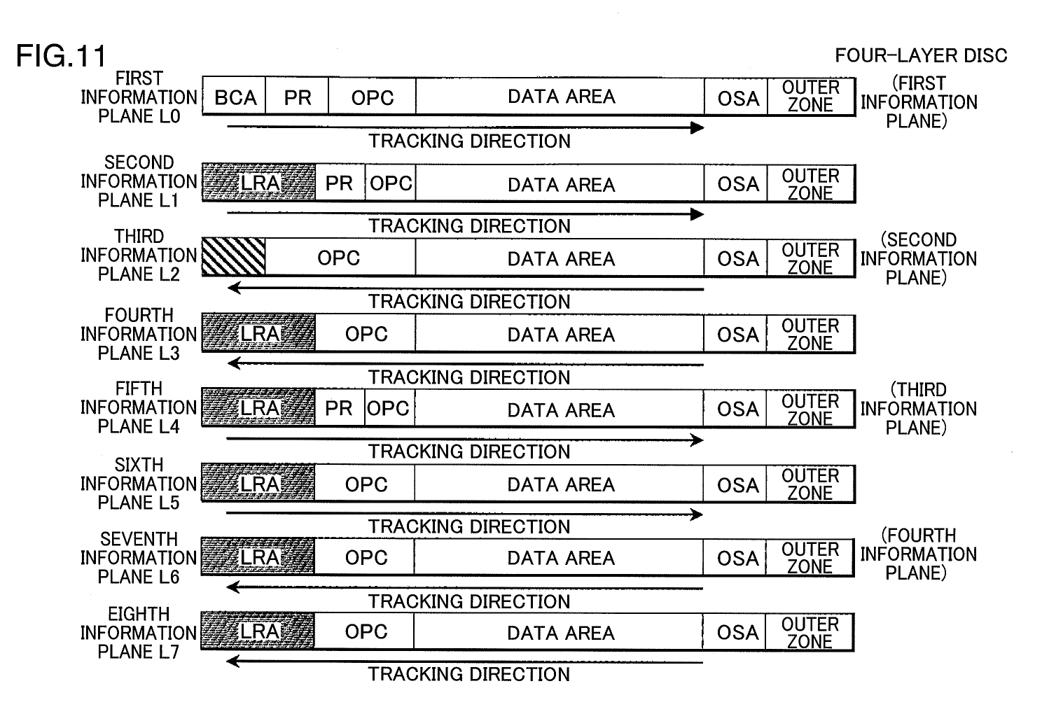

Next, radial area configurations of an eight-layer optical disc medium according to this embodiment are described. FIG. 11 is a chart showing the radial area configuration of the eight-layer optical disc medium according to this embodiment. A first information plane L0 of the eight-layer optical disc medium shown in FIG. 11 has an area configuration similar to those of the one-layer optical disc medium and the first information plane L0 of the two-layer optical disc medium and the four-layer optical disc medium described above. However, a part corresponding to the read-out zone in the one-layer optical disc medium becomes an outer zone. A third information plane L2 of the eight-layer optical disc medium has an area configuration similar to those of the second information plane L1 of the two-layer optical disc medium and the second information plane L1 of the four-layer optical disc medium shown in FIG. 10. However, the read-out zone at the inner circumferential side of the second information plane L1 of the two-layer optical disc medium is not a recording/reproduction end in the eight-layer optical disc medium and, hence, becomes an inner zone. A fifth information plane L4 of the eight-layer optical disc medium has an area configuration similar to that of the third information plane L2 of the four-layer optical disc medium shown in FIG. 10. A seventh information plane L6 of the eight-layer optical disc medium has an area configuration similar to that of the fourth information plane L3 of the four-layer optical disc medium shown in FIG. 10. However, a part corresponding to the read-out-in area of the four-layer optical disc medium becomes an inner zone.

The respective second, fourth, sixth and eighth information planes L1, L3, L5 and L7 of the eight-layer optical disc medium are information planes newly added in the eight-layer optical disc medium. On the second information plane L1, a low reflectivity area (LRA), a pre-recorded area (PR), a learning area and a DMA area (OPC, DMA) are arranged in an inner circumferential area, an inner circumferential side serves as an inner zone and an outer circumferential side serves as an outer zone. In this case, addresses of the second information plane L1 are recorded in an order from the inner circumferential side to the outer circumferential side, wherefore recording/reproduction is performed from the inner circumferential side to the outer circumferential side.

On the fourth information plane L3, a low reflectivity area (LRA), a learning area and a DMA area (OPC, DMA) are arranged in an inner circumferential area, an inner circumferential side serves as an inner zone and an outer circumferential side serves as an outer zone. In this case, addresses of the fourth information plane L3 are recorded in an order from the outer circumferential side to the inner circumferential side, wherefore recording/reproduction is performed from the outer circumferential side to the inner circumferential side.

On the sixth information plane L5, a low reflectivity area (LRA), a learning area and a DMA area (OPC, DMA) are arranged in an inner circumferential area, an inner circumferential side serves as an inner zone and an outer circumferential side serves as an outer zone. In this case, addresses of the sixth information plane L5 are recorded in an order from the inner circumferential side to the outer circumferential side, wherefore recording/reproduction is performed from the inner circumferential side to the outer circumferential side.

On the eighth information plane L7, a low reflectivity area (LRA), a learning area and a DMA area (OPC, DMA) are arranged in an inner circumferential area, an inner circumferential side serves as a read-out zone and an outer circumferential side serves as an outer zone. In this case, addresses of the eighth information plane L7 are recorded in an order from the outer circumferential side to the inner circumferential side, wherefore recording/reproduction is performed from the outer circumferential side to the inner circumferential side.

Information is successively recorded/reproduced from the inner circumferential side to the outer circumferential side of the first information plane L0, from the outer circumferential side to the inner circumferential side of the third information plane L2, the inner circumferential side to the outer circumferential side of the fifth information plane L4, from the outer circumferential side to the inner circumferential side of the seventh information plane L6, from the inner circumferential side to the outer circumferential side of the second information plane L1, from the outer circumferential side to the inner circumferential side of the fourth information plane L3, from the inner circumferential side to the outer circumferential side of the sixth information plane L5 and from the outer circumferential side to the inner circumferential side of the eighth information plane L7, wherefore real-time recording at a high transfer rate such as video recording/reproduction can be performed for a long time.

The addresses are counted up from the inner circumferential side to the outer circumferential side on the first, second, fifth and sixth information planes while being counted up from the outer circumferential side to the inner circumferential side on the third, fourth, seventh and eighth information planes. By using complements of the addresses of the respective information planes between the first and third information planes, between the fifth and seventh information planes, between the second and fourth information planes and between the sixth and eighth information planes, in-layer addresses can be expressed by bit numbers of in-layer addresses of one information plane.

Further, since relationships between the addresses of the respective information planes and the radial positions can also be known, a high-speed access is possible. Specifically, on the first to eighth information planes, information is recorded or reproduced from the inner circumferential side to the outer circumferential side of the optical disc medium on the information planes where MOD(n/4)=1, 2 while being recorded or reproduced from the outer circumferential side to the inner circumferential side of the optical disc medium on the information planes where MOD(n/4)=3, 0. Thus, real-time recording at a high transfer rate such as video recording/reproduction can be performed for a long time. It should be noted that MOD(n/4) represents a remainder when the number n of the information plane is divided by a divisor of 4.

Next, other radial area configurations of the eight-layer optical disc medium according to this embodiment are described.

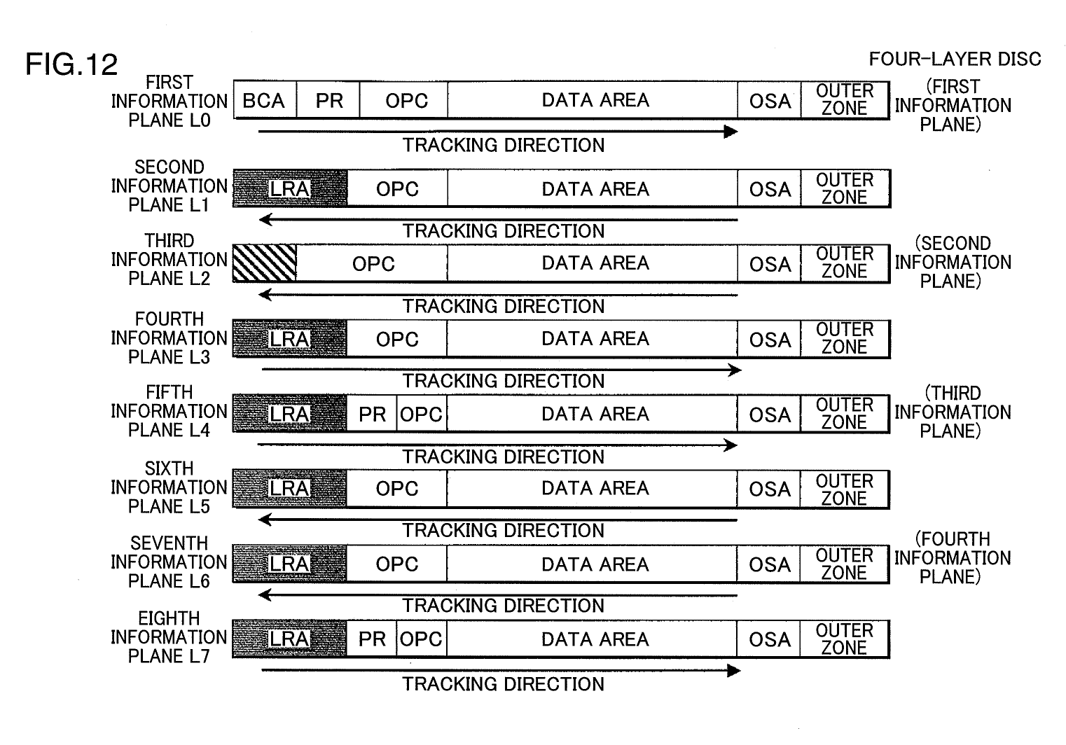

FIG. 12 is a chart showing the other radial area configurations of the eight-layer optical disc medium according to this embodiment. In the eight-layer optical disc medium shown in FIG. 12, a first information plane L0 has an area configuration similar to those of the one-layer optical disc medium and the first information planes L0 of the two-layer optical disc medium and the four-layer optical disc medium. However, a part corresponding to the read-out zone in the one-layer optical disc medium becomes an outer zone.

A third information plane L2 of the eight-layer optical disc medium has an area configuration similar to those of the second information plane L1 of the two-layer optical disc medium and the second information plane L1 of the four-layer optical disc medium shown in FIG. 10. However, the read-out zone at the inner circumferential side of the second information plane L1 of the two-layer optical disc medium is not a recording/reproduction end in the eight-layer optical disc medium and, hence, becomes an inner zone.

A fifth information plane L4 of the eight-layer optical disc medium has an area configuration similar to that of the third information plane L2 of the four-layer optical disc medium shown in FIG. 10. A seventh information plane L6 of the eight-layer optical disc medium has an area configuration similar to that of the fourth information plane L3 of the four-layer optical disc medium shown in FIG. 10. However, a part corresponding to the read-out area of the four-layer optical disc medium becomes an inner zone.

The respective second, fourth, sixth and eighth information planes L1, L3, L5 and L7 of the eight-layer optical disc medium are information planes newly added in the eight-layer optical disc medium. On the second information plane L1 of the eight-layer optical disc medium, a low reflectivity area (LRA), a learning area and a DMA area (OPC, DMA) are arranged in an inner circumferential area, an inner circumferential side serves as a read-in zone and an outer circumferential side serves as an outer zone. In this case, addresses of the second information plane L1 are recorded in an order from the outer circumferential side to the inner circumferential side, wherefore recording/reproduction is performed from the outer circumferential side to the inner circumferential side. On the fourth information plane L3 of the eight-layer optical disc medium, a low reflectivity area (LRA), a learning area and a DMA area (OPC, DMA) are arranged in an inner circumferential area, an inner circumferential side serves as an inner zone and an outer circumferential side serves as an outer zone. In this case, addresses of the fourth information plane L3 are recorded in an order from the inner circumferential side to the outer circumferential side, wherefore recording/reproduction is performed from the inner circumferential side to the outer circumferential side.

On the sixth information plane L5 of the eight-layer optical disc medium, a low reflectivity area (LRA), a learning area and a DMA area (OPC, DMA) are arranged in an inner circumferential area, an inner circumferential side serves as an inner zone and an outer circumferential side serves as an outer zone. In this case, addresses of the sixth information plane L5 are recorded in an order from the outer circumferential side to the inner circumferential side, wherefore recording/reproduction is performed from the outer circumferential side to the inner circumferential side. On the eighth information plane L7, a low reflectivity area (LRA), a pre-recorded area (PR), a learning area and a DMA area (OPC, DMA) are arranged in an inner circumferential area, an inner circumferential side serves as an inner zone and an outer circumferential side serves as an outer zone. In this case, addresses of the eighth information plane L7 are recorded in an order from the inner circumferential side to the outer circumferential side, wherefore recording/reproduction is performed from the inner circumferential side to the outer circumferential side.

Information is successively recorded/reproduced from the inner circumferential side to the outer circumferential side of the first information plane L0, from the outer circumferential side to the inner circumferential side of the third information plane L2, the inner circumferential side to the outer circumferential side of the fifth information plane L4, from the outer circumferential side to the inner circumferential side of the seventh information plane L6, from the inner circumferential side to the outer circumferential side of the eighth information plane L7, from the outer circumferential side to the inner circumferential side of the sixth information plane L5, from the inner circumferential side to the outer circumferential side of the fourth information plane L3 and from the outer circumferential side to the inner circumferential side of the second information plane L1, wherefore real-time recording at a high transfer rate such as video recording/reproduction can be performed for a long time.

The addresses are counted up from the inner circumferential side to the outer circumferential side on the first, fourth, fifth and eighth information planes L0, L3, L4 and L7 while being counted up from the outer circumferential side to the inner circumferential side on the second, third, sixth and seventh information planes L1, L2, L5 and L6. By using complements of the addresses of the respective information planes between the first and third information planes, between the fifth and seventh information planes, between the second and fourth information planes and between the sixth and eighth information planes, in-layer addresses can be expressed by bit numbers of in-layer addresses of one information plane.

Further, since relationships between the addresses of the respective information planes and the radial positions can also be known, a high-speed access is possible. Specifically, on the first to eighth information planes, information is recorded or reproduced from the inner circumferential side to the outer circumferential side of the optical disc medium on the information planes where MOD(n/4)=0, 1 while being recorded or reproduced from the outer circumferential side to the inner circumferential side of the optical disc medium on the information planes where MOD(n/4)=2, 3. Thus, real-time recording at a high transfer rate such as video recording/reproduction can be performed for a long time.

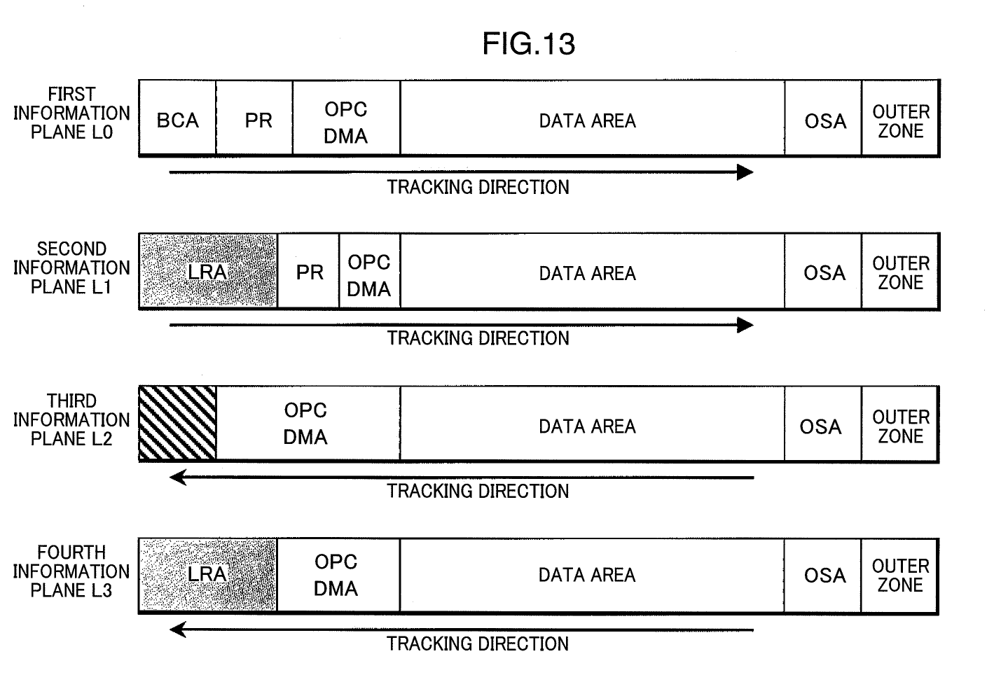

Next, still other radial area configurations of the eight-layer optical disc medium according to this embodiment are described. FIG. 13 is a chart showing the other radial area configurations of the eight-layer optical disc medium different from those of FIG. 10. What is different from FIG. 10 is that the area configurations of the second and third information planes L1, L2 of FIG. 10 are switched. By adopting the area configurations of FIG. 13, a new information plane can be inserted between the first and third information planes L0, L2 having the area configurations similar to those of the two-layer optical disc medium, whereby the total interlayer thickness of the entire disc can be reduced to thicken the disc outer surface.

By adopting such area configurations, information can be successively recorded/reproduced from the inner circumferential side to the outer circumferential side of the first information plane L0, from the outer circumferential side to the inner circumferential side of the third information plane L2, from the inner circumferential side to the outer circumferential side of the second information plane L1 and from the outer circumferential side to the inner circumferential side of the fourth information plane L3. Thus, real-time recording at a high transfer rate such as video recording/reproduction can be performed for a long time. Further, the addresses are counted up from the inner circumferential side to the outer circumferential side on the first and second information planes L0, L1 while being counted up from the outer circumferential side to the inner circumferential side on the third and fourth information planes L2 L3. By using complements of the addresses of the respective information planes between the first and third information planes and between the second and fourth information planes, in-layer addresses can be expressed by bit numbers of in-layer addresses of one information plane. Further, since relationships between the addresses of the first and third information planes L0, L2 and the second and fourth information planes L1, L3 and the radial positions can also be known, a high-speed access is possible.

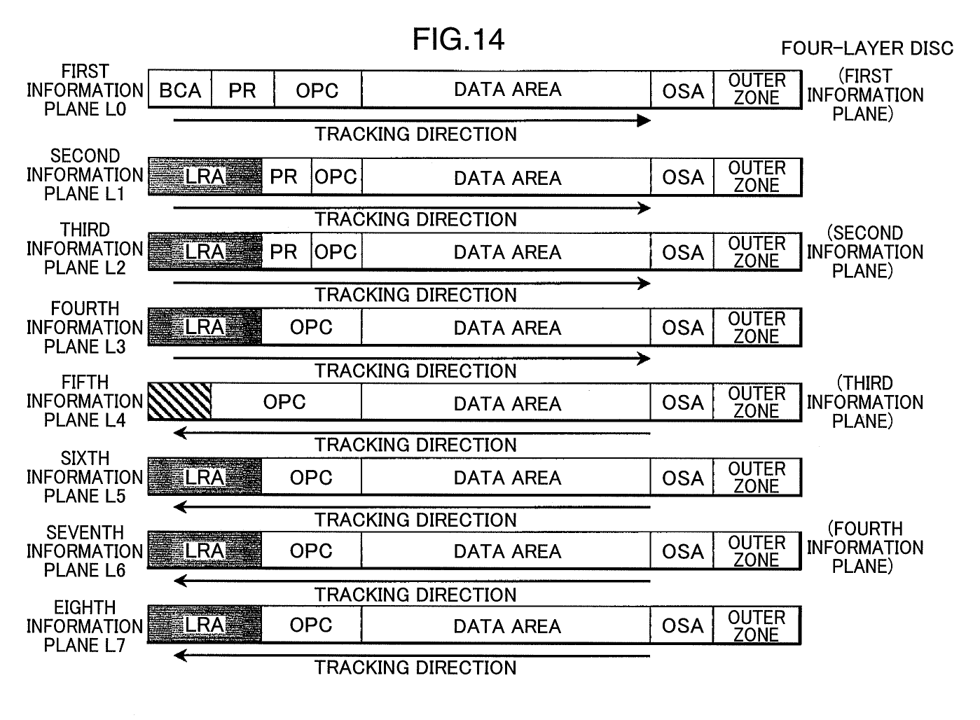

Next, further other radial area configurations of the eight-layer optical disc medium according to this embodiment are described. FIG. 14 is a chart showing the other radial area configurations of the eight-layer optical disc according to this embodiment. In the eight-layer optical disc medium shown in FIG. 14, a first information plane L0 has a disc layout similar to the one-layer optical disc medium and those of the first information planes L0 of the two-layer optical disc medium and the four-layer optical disc medium. However, a part corresponding to the read-out zone of the one-layer optical disc medium serves as an outer zone.

A fifth information plane L4 has an area configuration similar to those of the second information plane L1 of the two-layer optical disc medium and the third information plane L2 of the four-layer optical disc medium shown in FIG. 13. However, the read-out zone at the inner circumferential side of the second information plane L1 of the two-layer optical disc medium is not a recording/reproduction end in the eight-layer optical disc medium and, hence, becomes an inner zone. Further, a third information plane L2 of the eight-layer optical disc medium has an area configuration similar to that of the second information plane L1 of the four-layer optical disc medium shown in FIG. 13.

A seventh information plane L6 of the eight-layer optical disc medium has an area configuration similar to that of the fourth information plane L3 of the four-layer optical disc medium shown in FIG. 13. However, a part corresponding to the read-out zone of the four-layer optical disc medium serves as an inner zone.

The respective second, fourth, sixth and eighth information planes L1, L3, L5 and L7 are information planes newly added in the eight-layer optical disc medium. On the second information plane L1, a low reflectivity area (LRA), a pre-recorded area (PR), a learning area and a DMA area (OPC, DMA) are arranged in an inner circumferential area, an inner circumferential side serves as an inner zone and an outer circumferential side serves as an outer zone. In this case, addresses of the second information plane L1 are recorded in an order from the inner circumferential side to the outer circumferential side, wherefore recording/reproduction is performed from the inner circumferential side to the outer circumferential side. On the fourth information plane L3, a low reflectivity area (LRA), a learning area and a DMA area (OPC, DMA) are arranged in an inner circumferential area, an inner circumferential side serves as an inner zone and an outer circumferential side serves as an outer zone. In this case, addresses of the fourth information plane L3 are recorded in an order from the inner circumferential side to the outer circumferential side, wherefore recording/reproduction is performed from the inner circumferential side to the outer circumferential side.

On the sixth information plane L5, a low reflectivity area (LRA), a learning area and a DMA area (OPC, DMA) are arranged in an inner circumferential area, an inner circumferential side serves as an inner zone and an outer circumferential side serves as an outer zone. In this case, addresses of the sixth information plane L5 are recorded in an order from the outer circumferential side to the inner circumferential side, wherefore recording/reproduction is performed from the outer circumferential side to the inner circumferential side. On the eighth information plane L7, a low reflectivity area (LRA), a learning area and a DMA area (OPC, DMA) are arranged in an inner circumferential area, an inner circumferential side serves as a read-out zone and an outer circumferential side serves as an outer zone. In this case, addresses of the eighth information plane L7 are recorded in an order from the outer circumferential side to the inner circumferential side, wherefore recording/reproduction is performed from the outer circumferential side to the inner circumferential side.

Information is successively recorded/reproduced from the inner circumferential side to the outer circumferential side of the first information plane L0, from the outer circumferential side to the inner circumferential side of the fifth information plane L4, the inner circumferential side to the outer circumferential side of the third information plane L2, from the outer circumferential side to the inner circumferential side of the seventh information plane L6, from the inner circumferential side to the outer circumferential side of the second information plane L1, from the outer circumferential side to the inner circumferential side of the sixth information plane L5, from the inner circumferential side to the outer circumferential side of the fourth information plane L3 and from the outer circumferential side to the inner circumferential side of the eighth information plane L7, wherefore real-time recording at a high transfer rate such as video recording/reproduction can be performed for a long time. Further, the addresses are counted up from the inner circumferential side to the outer circumferential side on the first to fourth information planes L0 to L3 while being counted up from the outer circumferential side to the inner circumferential side on the fifth to eighth information planes L4 to L7. By using complements of the addresses of the respective information planes between the first and fifth information planes, between the third and seventh information planes, between the second and sixth information planes and between the fourth and eighth information planes, in-layer addresses can be expressed by bit numbers of in-layer addresses of one information plane. Further, since relationships between the addresses of the respective information planes and the radial positions can also be known, a high-speed access is possible. In other words, on a plurality of first to n-th (n=8) information planes, information is recorded or reproduced from the inner circumferential side to the outer circumferential side of the disc on the first to (n/2)-th information planes while being recorded or reproduced from the outer circumferential side to the inner circumferential side of the disc on the (n/2+1)-th to the n-th information planes, wherefore real-time recording at a high transfer rate such as video recording/reproduction can be performed for a long time.

Next, a method for manufacturing the multi-layer information recording medium according to this embodiment having the above area configurations is described.

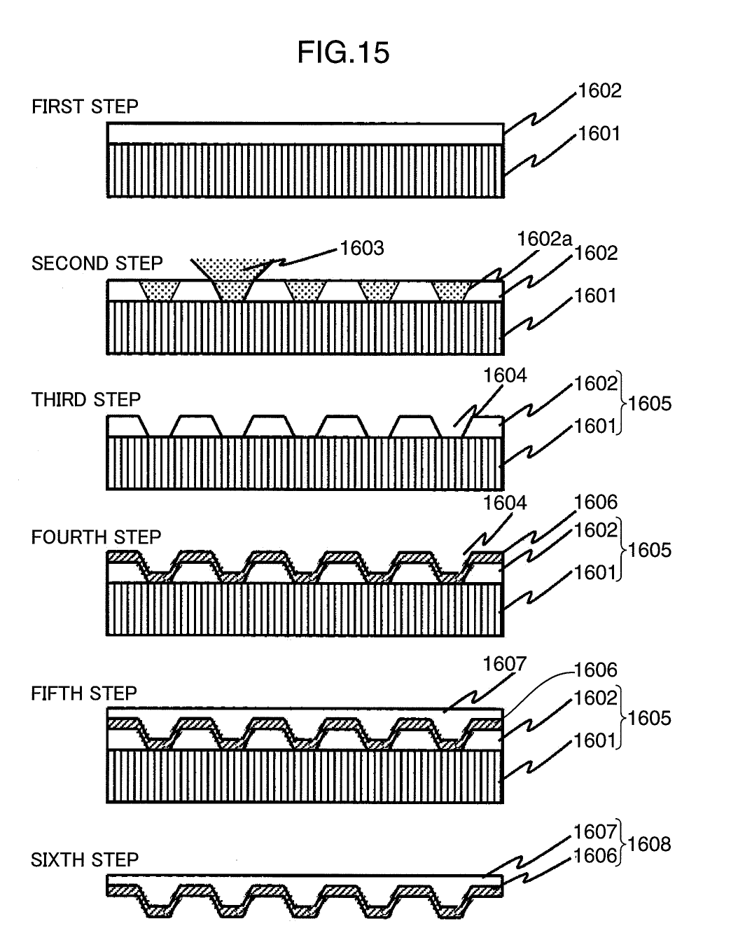

FIG. 15 is diagrams showing a production method for a stamper as a mold for producing a substrate used to manufacture a multi-layer optical disc medium according to this embodiment. First of all, a photosensitive material such as a photoresist is applied onto a glass plate 1601 to form a photosensitive film 1602 (see first step of FIG. 15) and, then, a pattern such as a pit or guide groove is exposed by optical recording by laser light 1603 (see second step of FIG. 15). In the second step of FIG. 15, a photosensitive film 1602a is an exposed part. The photosensitive material in the exposed part is removed via a development step, whereby an optical recording master 1605 formed with a pattern 1604 such as the pit or guide groove is produced (see third step of FIG. 15). The shape of the pattern 1604 such as the pit or guide groove formed in the photosensitive film 1602 is transferred to a conductive film 1606 formed by sputtering, deposition or like method (see fourth step of FIG. 15). A plating film 1607 is formed to increase the rigidity and thickness of the conductive film 1606 (see fifth step of FIG. 15). Subsequently, a stamper 1608 is produced by peeling off the conductive film 1606 and the plating film 1607 from an interface between the photosensitive film 1602 and the conductive film 1606 (see sixth step of FIG. 15).

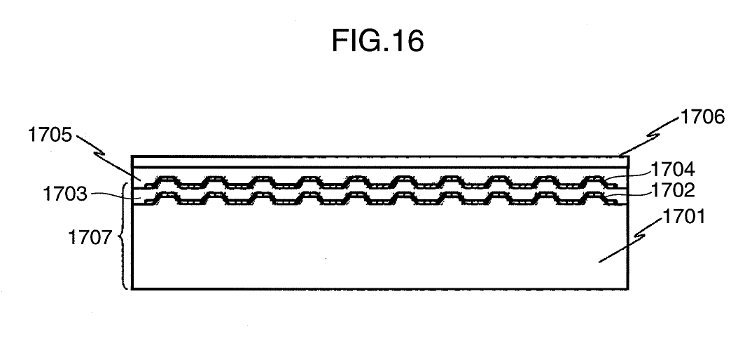

FIG. 16 is a section of the multi-layer information recording medium according to this embodiment. This multi-layer information recording medium includes a first signal substrate 1701 having an information plane of a pit or guide groove as an uneven shape transfer-formed on one side, a first thin film layer 1702 arranged on the uneven surface of the first signal substrate 1701, a second signal substrate 1703 having an information plane of a pit or guide groove as an uneven shape transfer-formed on a surface thereof opposite to the one adhered to the first thin film layer 1702, a second thin film layer 1704 arranged on the uneven surface of the second signal substrate 1703, a transparent substrate 1706 arranged to face the second substrate 1703 and a transparent layer 1705 provided to adhere the second thin film layer 1704 and the transparent substrate 1706.

A pit or guide groove is transfer-formed as an uneven shape on one side of the first signal substrate 1701 by injection compression molding or the like using the stamper 1608 shown in the sixth step of FIG. 15. An information recording layer is formed by forming a thin film layer on the information plane in this way. The thickness of the first signal substrate 1701 is, for example, about 1.1 mm. The first and second thin film layers 1702, 1704 include a recording film and a reflective film. The first and second thin film layers 1702, 1704 are formed by sputtering, deposition or like method on the surfaces of the first and second signals substrates 1701, 1703 formed with the pit or guide groove.

The second signal substrate 1703 is formed by spin-coating a light-curing resin. A transfer substrate formed with a pit or guide groove as an uneven shape on one side like the stamper 1608 shown in the sixth step of FIG. 15 and the first signal substrate 1701 is adhered using the light-curing resin such that an information plane faces the first signal substrate 1701. The second signal substrate 1703 is formed by peeling off the transfer substrate from an interface with the light-curing resin after the light curing of the light-curing resin. The transparent substrate 1706 is made of a transparent material (having transparency) for transmitting recording/reproducing light and has a thickness of, e.g. about 0.1 mm. The transparent layer 1705 is provided to bond two substrates 1706, 1707 to each other and made of an adhesive such as a light-curing resin or a pressure sensitive adhesive. Recording/reproduction on/from such a multi-layer information recording medium is performed by causing laser light to be incident through the transparent substrate 1706.

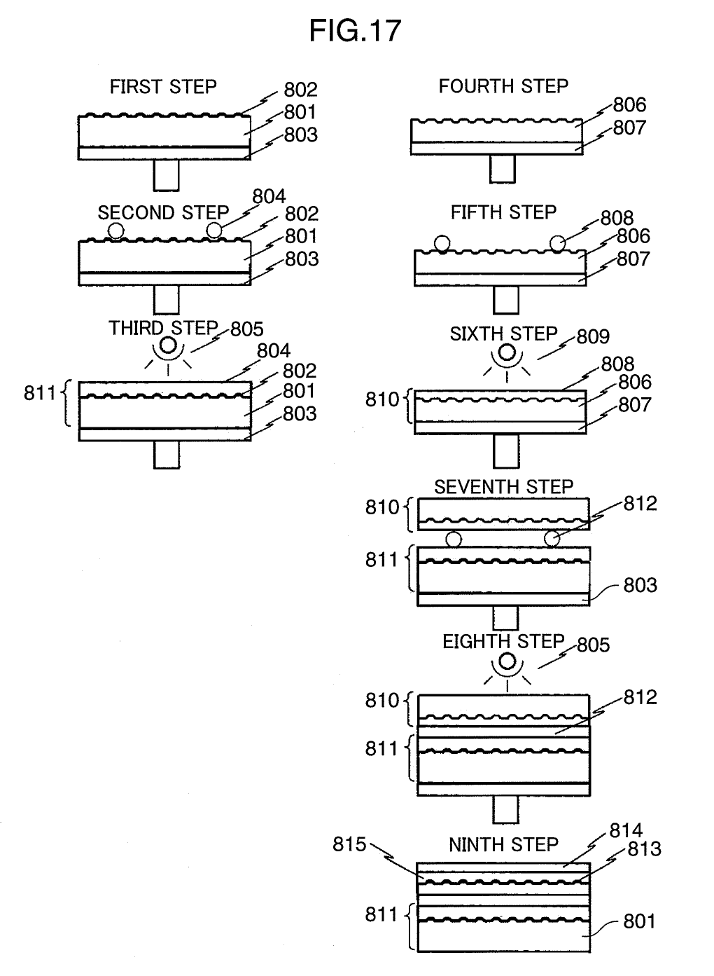

Next, a method for manufacturing the multi-layer information recording medium according to this embodiment is described. FIG. 17 is a diagram showing the method for manufacturing the multi-layer information recording medium according to this embodiment.

First of all, a first thin film layer 802 including a recording film material and a reflective film material is formed by sputtering, deposition or like method on a surface of a first signal substrate 801 formed with a signal surface by a pit or guide groove, whereby an information recording layer is formed. An area of the first thin film layer 802 formed on the signal surface is determined by a masked area of the substrate at the time of sputtering or deposition.

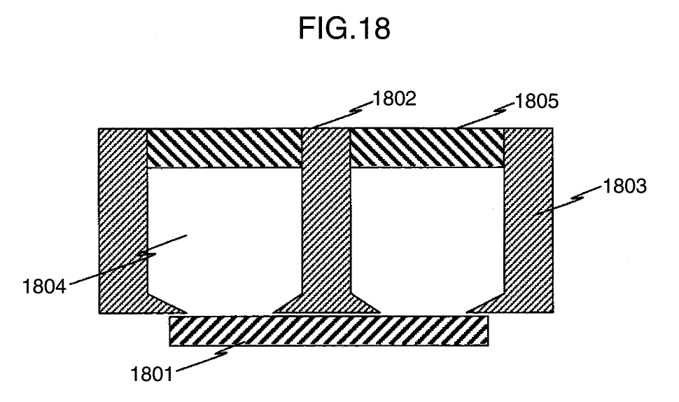

FIG. 18 is a section showing the structure of a sputterer. First of all, a substrate 1801 conveyed to the sputterer is placed at a position where an inner mask 1802 and an outer mask 1803 are substantially in contact. The inner mask 1802 is so structured as to entirely cover an inner circumferential area of the substrate lest a thin film layer should be formed on the inner periphery including the central hole of the substrate. The outer mask 1803 is so structured as to prevent a sputter film from moving to the rear surface of the substrate lest a thin film layer should be formed on the outer periphery of a specific substrate. In a space 1804 set to have a vacuum atmosphere by a vacuum pump or the like, plasma is generated by the introduction of gas such as argon gas and the discharge. Ions (here, argon ions) produced in the plasma are caused to collide with the material of a target 1805 placed at the base ends of the inner mask 1802 and the outer mask 1803, thereby scattering atoms and molecules constituting the material of the target 1805 onto the substrate to form a thin film on the substrate outer surface.

An area where the first thin film layer 802 is formed can be easily changed by changing the diameter of the inner mask 1802 and that of the outer mask 1803. A surface of the first signal substrate 801 opposite to the one formed with the first thin film layer 802 is fixed onto a rotary table 803 by means such as vacuuming (see first step of FIG. 17). A light-curing resin 804 is concentrically applied on a desired radius position of the first thin film layer 802 on the first signal substrate 801 fixed to the rotary table 803, using a dispenser (see second step of FIG. 17).

Then, the light-curing resin 804 is stretched by spinning the rotary table 803 (see third step of FIG. 17). The stretched light-curing resin 804 can have superfluous resin and bubbles removed by a centrifugal force. At this time, the thickness of the stretched light-curing resin 804 can be controlled to a desired value by arbitrarily setting the viscosity of the light-curing resin 804, the rotating speed and time of the spin rotation, and surrounding atmosphere of the spin rotation such as temperature and humidity. After the stop of the spin rotation, the stretched light-curing resin 804 is cured by light irradiation from a light emitter 805. In this way, a first substrate 811 made up of the first signal substrate 801, the first thin film layer 802 and the light-curing resin 804 is produced.

Next, a second information plane is formed on the first signal substrate 801. First of all, a transfer substrate 806 formed with a pit or guide groove as an uneven shape on one side like the stamper 1608 shown in the sixth step of FIG. 15 and the first signal substrate 1701 shown in FIG. 16 is fixed onto a rotary table 807 (see fourth step of FIG. 17). A light-curing resin 808 is concentrically applied on a desired radius position of the transfer substrate 806 fixed to the rotary table 807, using a dispenser (see fifth step of FIG. 17). Then, the light-curing resin 808 is stretched by spinning the rotary table 807 (see sixth step of FIG. 17). The stretched light-curing resin 808 can be controlled to a desired value similar to the light-curing resin 804. After the stop of the spin rotation, the stretched light-curing resin 808 is cured by light irradiation from a light emitter 809. In this way, a second substrate 810 made up of the transfer substrate 806 and the light-curing resin 808 is produced.

On one rotary table 803, the two substrates 810, 811 are placed one over the other with a light-curing resin 812 therebetween such that the light-curing resin layers thereof face each other (see seventh step of FIG. 17), and are spun by the rotary table 802 in a united state. The light-curing resin 812 is cured by light irradiation from the light emitter 805 after being controlled to a desired thickness by the spin rotation (see eighth step of FIG. 17). By peeling off the transfer substrate 806 from an interface between the transfer substrate 806 and the light-curing resin 808 after the substrates 810, 811 are united by the light-curing resin 812, a second information plane is formed on the first signal substrate 801 (see ninth step of FIG. 17).

The light-curing resin 804 used here is selected to have good adhesion to the first thin film layer 802 and the light-curing resin 812. The light-curing resin 808 is selected to have good peelability from the transfer substrate 806 and good adhesion to the light-curing resin 812. The viscosities of the respective light-curing resins are about 150 Pa·s to be thinned as much as possible.

A second thin film layer 813 including a recording film material and a reflective film material is formed by sputtering, deposition or like method on the second information plane formed on the first signal substrate 801. A transparent layer 815 formed upon adhering the second thin film layer 813 and a transparent substrate 814 is transparent (having transparency) for transmitting recording/reproducing light and is formed by having bubbles included in a light-curing resin removed and having the thickness thereof controlled by the spin rotation after the light-curing resin is applied to the second thin film layer 813, and by being irradiated with light to be cured after being stretched.

Although the multi-layer formation of the BD whose base member has a thickness of 0.1 mm is described in the above embodiment, the present invention is not particularly limited thereto and is also applicable to the multi-layer formation of HD DVDs whose base members have a thickness of 0.6 mm and to the same types of multi-layer optical disc media.

The specific embodiment described above mainly embraces inventions having the following constructions.

A multi-layer information recording medium according to one aspect of the present invention is the one comprising a plurality of layered information planes and adapted to record or reproduce information by light, wherein the plurality of information planes include at least one information plane having a first reflecting surface for reflecting light with a first reflected light power when the light is incident and another information plane having a second reflecting surface for reflecting the light with a second reflected light power smaller than the first reflected light power.

According to this construction, the plurality of information planes of the multi-layer information recording medium include at least one information plane having the first reflecting surface for reflecting the light with the first reflected light power when the light is incident and the other information plane having the second reflecting surface for reflecting the light with the second reflected light power smaller than the first reflected light power.

Thus, light can be reliably pulled in for focusing on at least one information plane coinciding with information planes of information recording media already on the market. Thus, lower compatibility with information recording media already on the market or of known formats can be assured, and information can be recorded/reproduced on/from the multi-layer information recording medium of a new format using an information recording/reproducing device already widely in use. Further, generally widely distributed information recording/reproducing devices can be effectively utilized and users can utilize multi-layer optical disc media newly on the market using existing information recording/reproducing devices.

Specifically, the multi-layer information recording medium includes three or more information recording surfaces, and information can be recorded on or reproduced from the information recording medium in an information recording/reproducing device compatible with only conventional two-layer information recording media by letting an inner circumferential area or outer circumferential area of each of the third and succeeding information recording surfaces have a physical property (reflectivity, transmissivity, groove property, pit property, etc.) different from that of the first and second information recording surfaces.

In the above multi-layer information recording medium, disc management information is preferably recorded on the first reflecting surface. According to this construction, the disc management information can be reproduced by irradiating the first reflecting surface with light.

In the above multi-layer information recording medium, it is preferable that an optical disc medium is further provided; that the second reflecting surface includes an inner circumferential area of the optical disc medium; and that the reflectivity of the inner circumferential area is lower than that of a data area for recording data.

According to this construction, the multi-layer information recording medium comprises the optical disc medium, the second reflecting surface includes the inner circumferential area of the optical disc medium and the reflectivity of the inner circumferential area is lower than that of the data area for recording data. Since the reflectivity of the inner circumferential area is set lower than that of the data area, light can be reliably pulled in for focusing on the inner circumferential area of the information plane coinciding with information planes of information recording media already on the market.

In the above multi-layer information recording medium, it is preferable that an optical disc medium is further provided; that the first and second reflecting surfaces each include an inner circumferential area of the optical disc medium and a data area for recording data; and that the reflectivities of the inner circumferential area and the data area of the second reflecting surface are lower than those of the inner circumferential area and the data area of the first reflecting surface.

According to this construction, data recorded in the data area of the first reflecting surface can be reliably reproduced since the reflectivities of the inner circumferential area and the data area of the second reflecting surface are lower than those of the inner circumferential area and the data area of the first reflecting surface.

In the above multi-layer information recording medium, it is preferable that the plurality of information planes include four information planes; that two of the four information planes reflect light with a specified first reflected light power when the light is incident on the first reflecting surface; and that the remaining two information planes reflect light with a second reflected light power smaller than the first reflected light power when the light is incident on the second reflecting surface.

According to this construction, the plurality of information planes include four information planes, and two of the four information planes reflect light with the specified first reflected light power when the light is incident on the first reflecting surface. Further, the remaining two information planes reflect light with the second reflected light power smaller than the first reflected light power when the light is incident on the second reflecting surface.

Accordingly, in the case of recording/reproducing on/from a four-layer information recording medium using an information recording/reproducing device compatible with two-layer information recording media, light can be reliably pulled in for focusing on the two of the four information planes. Thus, compatibility between two-layer information recording media already on the market and four-layer multi-layer information recording media can be assured.

In the above multi-layer information recording medium, it is preferable that the plurality of information planes include eight information planes; that four of the eight information planes reflect light with a specified first reflected light power when the light is incident on the first reflecting surface; and that the remaining four information planes reflect light with a second reflected light power smaller than the first reflected light power when the light is incident on the second reflecting surface.

According to this construction, the plurality of information planes include eight information planes, and four of the eight information planes reflect light with the specified first reflected light power when the light is incident on the first reflecting surface. Further, the remaining four information planes reflect light with the second reflected light power smaller than the first reflected light power when the light is incident on the second reflecting surface.

Accordingly, in the case of recording/reproducing on/from an eight-layer information recording medium using an information recording/reproducing device compatible with four-layer information recording media, light can be reliably pulled in for focusing on the four of the eight information planes. Thus, compatibility between four-layer information recording media already on the market and eight-layer multi-layer information recording media can be assured.

In the above multi-layer information recording medium, it is preferable that, if a ratio of the first reflected light power to an emitted light power on the first reflecting surface is a higher reflectivity ratio Rb and a ratio of the second reflected light power to an emitted light power on the second reflecting surface is a lower reflectivity ratio Rd, the lower reflectivity ratio Rd lies in a range of 0≦Rd<3.5% and the higher reflectivity ratio Rb lies in a range of 3.5%≦Rb≦8%.

According to this construction, if the ratio of the first reflected light power to the emitted light power on the first reflecting surface is the higher reflectivity ratio Rb and the ratio of the second reflected light power to the emitted light power on the second reflecting surface is the lower reflectivity ratio Rd, the lower reflectivity ratio Rd lies in the range of 0≦Rd<3.5% and the higher reflectivity ratio Rb lies in the range of 3.5%≦Rb≦8%.

Reflectivity ratios of conventional two-layer information recording media are specified to be equal to or higher than 3.5% and equal to or lower than 8%. By setting the range of the lower reflectivity ratio Rd lower than this range, light can be reliably pulled in for focusing, wherefore information can be recorded/reproduced on/from multi-layer information recording media having four or more layers using, for example, an information recording/reproducing device compatible with two-layer information recording media.

In the above multi-layer information recording medium, a relationship between the lower reflectivity ratio Rd and the higher reflectivity ratio Rb is preferably 2×Rd<Rb. According to this construction, light can be reliably pulled in for focusing by setting the higher reflectivity ratio Rb higher than the twofold of the lower reflectivity ratio Rd since the relationship between the lower reflectivity ratio Rd and the higher reflectivity ratio Rb is preferably 2×Rd<Rb.

In the above multi-layer information recording medium, the lower reflectivity ratio Rd is sufficiently lower than the higher reflectivity ratio Rb and substantially 0. According to this construction, light can be reliably pulled in for focusing since the lower reflectivity ratio Rd is sufficiently lower than the higher reflectivity ratio Rb and substantially 0. For example, that the lower reflectivity ratio Rd is sufficiently lower than the higher reflectivity ratio Rb means that the lower reflectivity ratio Rd is equal to or below the level of reflected light at the time of recording information.

In the above multi-layer information recording medium, it is preferable that an optical disc medium is further provided; and that the first and second reflecting surfaces are provided in a range within 24 mm from the center of rotation of the optical disc medium.

According to this construction, the multi-layer information recording medium comprises the optical disc medium, and the first and second reflecting surfaces are provided in the range within 24 mm from the center of rotation of the optical disc medium. Thus, light can be reliably pulled in for focusing on the inner circumferential area corresponding to the range within 24 mm from the center of rotation of the optical disc medium.

In the above multi-layer information recording medium, the first reflecting surface preferably includes a BCA area for recording identification information peculiar to the multi-layer information recording medium by burst-cutting a reflective layer.

According to this construction, the identification information can be reliably reproduced from the BCA area of the multi-layer information recording medium even by information recording/reproducing devices already on the market since the first reflecting surface includes the BCA area for recording the identification information peculiar to the multi-layer information recording medium by burst-cutting the reflective layer.

In the above multi-layer information recording medium, the second reflecting surface is preferably pre-recorded by laser light. According to this construction, the second reflected light power on the second reflecting surface of the other information plane can be made smaller than the first reflected light power since pre-recording is made on the second reflecting surface by the laser light.

In the above multi-layer information recording medium, the second reflecting surface is preferably formed by burst-cutting a reflective surface. According to this construction, the second reflected light power can be smaller than the first reflected light power on the second reflecting surface of the other information plane since the second reflecting surface is formed by burst-cutting the reflective surface.

In the above multi-layer information recording medium, the second reflecting surface is preferably formed with no reflective layer. According to this construction, the second reflected light power can be smaller than the first reflected light power on the second reflecting surface of the other information plane since the second reflecting surface for reflecting light with the second reflected light power is formed with no reflective layer.

In the above multi-layer information recording medium, a thickness between the respective adjacent information planes are preferably 6 μm to 30 μm. According to this construction, interference of diffracted lights from the respective adjacent information planes (inter-layer interference) can be reduced by setting the thickness between the respective adjacent information planes to 6 μm to 30 μm.

In the above multi-layer information recording medium, disc management information is recorded at least at two positions of the first reflecting surface. According to this construction, even if the disc management information cannot be read from one information plane, it can be read from the other information plane since the disc management information is recorded at least at two positions of the first reflecting surface.

In the above multi-layer information recording medium, areas where the disc management information is recorded are preferably so arranged as not to overlap on the upper and lower information planes. According to this construction, even if the disc management information cannot be read from one information plane, it can be reliably read from the other information plane since the areas where the disc management information is recorded are so arranged as not to overlap on the upper and lower information planes.

In the above multi-layer information recording medium, it is preferable that a write-prohibit flag for prohibiting data recording in a user data area is recorded for each information plane; and that data recording on the information plane prohibited by the write-prohibit flag is prohibited.

According to this construction, the write-prohibit flag for prohibiting data recording in the user data area is recorded for each information plane, and data recording on the information plane prohibited by the write-prohibit flag is prohibited. Thus, compatibility with information recording media having less layers can be assured by prohibiting data recording on the other information plane of the plurality of information planes of the multi-layer information recording medium.

In the above multi-layer information recording medium, it is preferable that the plurality of information planes include the first to n-th information planes; that recording or reproduction is performed from an inner circumferential side to an outer circumferential side of the optical disc medium on the information planes where MOD(n/4)=1, 2 (where MOD is a remainder when the numerical value n is divided by a divisor of 4) while being performed from the outer circumferential side to the inner circumferential side of the optical disc medium on the information planes where MOD(n/4)=3, 0.

According to this construction, the plurality of information planes include the first to n-th information planes, and recording or reproduction is performed from the inner circumferential side to the outer circumferential side of the optical disc medium on the information planes where MOD(n/4)=1, 2 (where MOD is a remainder when the numerical value n is divided by a divisor of 4). Further, recording or reproduction is performed from the outer circumferential side to the inner circumferential side of the optical disc medium on the information planes where MOD(n/4)=3, 0.

Thus, for example, in the case of a four-layer information recording medium, recording or reproduction is performed from the inner circumferential side to the outer circumferential side on the first and second information planes while being performed from the outer circumferential side to the inner circumferential side on the third and fourth information planes. Therefore, real-time recording at a high transfer rate such as video recording/reproduction can be performed for a long time.

In the above multi-layer information recording medium, it is preferable that addresses are recorded from the inner circumferential side to the outer circumferential side of the optical disc medium on the information planes where MOD(n/4)=1, 2; and that addresses are recorded from the outer circumferential side to the inner circumferential side of the optical disc medium on the information planes where MOD(n/4)=3, 0.

According to this construction, the addresses are recorded from the inner circumferential side to the outer circumferential side of the optical disc medium on the information planes where MOD(n/4)=1, 2, and the addresses are recorded from the outer circumferential side to the inner circumferential side of the optical disc medium on the information planes where MOD(n/4)=3, 0.

Thus, for example, in the case of a four-layer information recording medium, information can be recorded or reproduced from the inner circumferential side to the outer circumferential side on the first and second information planes, and information can be recorded or reproduced from the outer circumferential side to the inner circumferential side on the third and fourth information planes.

In the above multi-layer information recording medium, it is preferable that the plurality of information planes include the first to n-th information planes (n is an even number); that recording or reproduction is performed from an inner circumferential side to an outer circumferential side of the optical disc medium on the first to (n/2)-th information planes while being performed from the outer circumferential side to the inner circumferential side of the optical disc medium on the (n/2+1)-th to n-th information planes.

According to this construction, the plurality of information planes include the first to n-th (n is an even number) information planes, and recording or reproduction is performed from the inner circumferential side to the outer circumferential side of the optical disc medium on the first to (n/2)-th information planes. Further, recording or reproduction is performed from the outer circumferential side to the inner circumferential side of the optical disc medium on the (n/2+1)-th to n-th information planes.

Thus, for example, in the case of an eight-layer information recording medium, information is recorded or reproduced from the inner circumferential side to the outer circumferential side on the first to fourth information planes, and information is recorded or reproduced from the outer circumferential side to the inner circumferential side on the fifth to eighth information planes. Therefore, real-time recording at a high transfer rate such as video recording/reproduction can be performed for a long time.

In the above multi-layer information recording medium, it is preferable that addresses are recorded from the inner circumferential side to the outer circumferential side of the optical disc medium on the first to (n/2)-th information planes; and that addresses are recorded from the outer circumferential side to the inner circumferential side of the optical disc medium on the (n/2+1)-th to n-th information planes.

According to this construction, the addresses are recorded from the inner circumferential side to the outer circumferential side of the optical disc medium on the first to (n/2)-th information planes, and the addresses are recorded from the outer circumferential side to the inner circumferential side of the optical disc medium on the (n/2+1)-th to n-th information planes.

Thus, for example, in the case of an eight-layer information recording medium, information can be recorded or reproduced from the inner circumferential side to the outer circumferential side on the first to fourth information planes, and information can be recorded or reproduced from the outer circumferential side to the inner circumferential side on the fifth to eighth information planes.

In the above multi-layer information recording medium, the first to n-th information planes are preferably formed to approach a laser incident surface in this order. According to this construction, the first to n-th information planes can be formed to approach the laser incident surface.

An information recording/reproducing device according to another aspect of the present invention is for recording or reproducing information on or from a multi-layer information recording medium including a plurality of layered information planes, the plurality of information planes including at least one information plane having a first reflecting surface for reflecting light with a first reflected light power when the light is incident and another information plane having a second reflecting surface for reflecting the light with a second reflected light power smaller than the first reflected light power, the information recording/reproducing device comprising a laser light emitter for emitting laser light for recording or reproducing a signal on or from a signal track of the multi-layer information recording medium; a spherical aberration correcting section for correcting the spherical aberration of the laser light; a controller for controlling the focal position of the laser light according to the information plane, to which the laser light is emitted; and a medium discriminator for discriminating the number of the information planes by emitting laser light to the first reflecting surface of the multi-layer information recording medium.

According to this construction, the plurality of information planes of the multi-layer information recording medium include at least one information plane having the first reflecting surface for reflecting the light with the first reflected light power when the light is incident and the other information plane having the second reflecting surface for reflecting the light with the second reflected light power smaller than the first reflected light power. Laser light for recording or reproducing a signal is emitted to the signal track of the multi-layer information recording medium to correct the spherical aberration of the laser light. The focal position of the laser light is controlled according to the information plane, to which the laser light is emitted, and the number of the information planes is discriminated by emitting the laser light to the first reflecting surface of the multi-layer information recording medium.

Thus, light can be reliably pulled in for focusing on at least one information plane coinciding with information planes of information recording media already on the market. Therefore, lower compatibility with information recording media already on the market or of known formats can be assured, and information can be recorded/reproduced on/from the multi-layer information recording medium of a new format using an information recording/reproducing device already widely in use.

In the above information recording/reproducing device, the medium discriminator preferably discriminates the number of the information planes from waveform information of a focus error signal. According to this construction, the number of the information planes can be accurately discriminated from the waveform information of the focus error signal.

In the above information recording/reproducing device, it is preferable to further comprise a flag setting section for setting a write-prohibit flag for prohibiting data recording in a user data area for each information plane and a recording section for not recording data on the information plane for which the write-prohibit flag is set by the flag setting section.

According to this construction, the write-prohibit flag for prohibiting data recording in the user data area is set for each information plane, and data is not recorded on the information plane for which the write-prohibit flag is set. Thus, data is not recorded on the other information plane out of the plurality of information planes of the multi-layer information recording medium, wherefore compatibility with information recording media having less layers can be assured.

A multi-layer information recording medium manufacturing method according to still another aspect of the present invention is for manufacturing a multi-layer information recording medium including a plurality of layered information planes, comprising a first step of forming a reflective layer on a substrate formed with an information plane on one side; a second step of forming a transparent intermediate layer having an information plane on the reflective layer; a third step of forming a reflective layer on an information plane side of the intermediate layer; a fourth step of forming a transparent protective layer after the plurality of information planes are formed by repeating the second and third steps a plurality of times; and a fifth step of forming a first reflective layer, which reflects light with a specified first reflected light power when the light is incident, on at least one information plane and forming a second reflecting surface, which reflects the light with a second reflected light power smaller than the first reflected light power, on another information plane.

According to this construction, the reflective layer is formed on the substrate formed with the information plane on one side in the first step. Subsequently, in the second step, the transparent intermediate layer having the information plane is formed on the reflective layer. Subsequently, in the third step, the reflective layer is formed on the information plane side of the intermediate layer. Subsequently, in the fourth step, the transparent protective layer is formed after the plurality of information planes are formed by repeating the second and third steps a plurality of times. Subsequently, in the fifth step, the first reflecting surface for reflecting light with the specified first reflected light power when the light is incident is formed on at least one information plane, and the second reflecting surface for reflecting the light with the second reflected light power smaller than the first reflected light power is formed on the other information plane.

Thus, light can be reliably pulled in for focusing on at least one information plane coinciding with information planes of information recording media already on the market, wherefore lower compatibility with information recording media already on the market or of known formats can be assured, and information can be recorded/reproduced on/from the multi-layer information recording medium of a new format using an information recording/reproducing device already widely in use.

In the above multi-layer information recording medium manufacturing method, the second reflecting surface is preferably formed by pre-recording on the other information plane by laser light in the fifth step.

According to this construction, the second reflected light power can be made smaller than the first reflected light power on the second reflecting surface of the other information plane since the second reflecting surface is formed by pre-recording on the other information plane by the laser light in the fifth step.

In the above multi-layer information recording medium manufacturing method, the second reflecting surface is preferably formed by burst-cutting the reflective layer beforehand by laser light in the fifth step.

According to this construction, the second reflected light power can be made smaller than the first reflected light power on the second reflecting surface of the other information plane since the second reflecting surface is formed on the other information plane by burst-cutting the reflective layer beforehand by the laser light in the fifth step.

In the above multi-layer information recording medium manufacturing method, the second reflecting surface is preferably formed by masking the other information plane upon forming the reflective layer in the first and third steps.

According to this construction, no reflective layer is formed on the second reflecting surface of the other information plane and the second reflected light power can be made smaller than the first reflected light power on the second reflecting surface of the other information plane since the second reflecting surface is formed by masking the other information plane upon forming the reflective layer in the first and third steps.

In the above multi-layer information recording medium manufacturing method, it is preferable that the plurality of information planes include the first to n-th information planes; that the information planes where MOD(n/4)=1, 2 (where MOD is a remainder when the numerical value n is divided by a divisor of 4) and the information planes where MOD(n/4)=3, 0 are formed such that spiral directions are opposite.

According to this construction, the plurality of information planes include the first to n-th information planes, and the information planes where MOD(n/4)=1, 2 (where MOD is a remainder when the numerical value n is divided by a divisor of 4) and the information planes where MOD(n/4)=3, 0 are formed such that spiral directions are opposite.

Thus, for example, in the case of a four-layer information recording medium, the tracking direction of the first and second information planes and that of the third and fourth information planes are opposite and it is no longer necessary to seek from the inner circumference to the outer circumference or from the outer circumference to the inner circumference. Therefore, real-time recording at a high transfer rate such as video recording/reproduction can be performed for a long time.

In the above multi-layer information recording medium manufacturing method, it is preferable that addresses are successively formed from an inner circumferential side to an outer circumferential side of the optical disc medium on the information planes where MOD(n/4)=1, 2; and that addresses are successively formed from the outer circumferential side to the inner circumferential side of the optical disc medium on the information planes where MOD(n/4)=3, 0.

According to this construction, the addresses are successively formed from the inner circumferential side to the outer circumferential side of the optical disc medium on the information planes where MOD(n/4)=1, 2, and the addresses are successively formed from the outer circumferential side to the inner circumferential side of the optical disc medium on the information planes where MOD(n/4)=3, 0.

Thus, for example, in the case of a four-layer information recording medium, information can be recorded or reproduced from the inner circumferential side to the outer circumferential side on the first and second information planes, and information can be recorded or reproduced from the outer circumferential side to the inner circumferential side on the third and fourth information planes.

In the above multi-layer information recording medium manufacturing method, it is preferable that the plurality of information planes include the first to n-th information planes (n is an even number); and that the first to (n/2)-th information planes and the (n/2+1)-th to n-th information planes are formed such that spiral directions are opposite.

According to this construction, the plurality of information planes include the first to n-th information planes (n is an even number), and the first to (n/2)-th information planes and the (n/2+1)-th to n-th information planes are formed such that spiral directions are opposite.

Thus, for example, in the case of an eight-layer information recording medium, the tracking direction of the first to fourth information planes is opposite to that of the fifth to eighth information planes, and it is no longer necessary to seek from the inner circumference to the outer circumference or from the outer circumference to the inner circumference. Therefore, real-time recording at a high transfer rate such as video recording/reproduction can be performed for a long time.

In the above multi-layer information recording medium manufacturing method, it is preferable that addresses are successively formed from an inner circumferential side to an outer circumferential side of the optical disc medium on the first to (n/2)-th information planes; and that addresses are successively formed from the outer circumferential side to the inner circumferential side of the optical disc medium on the (n/2+1)-th to n-th information planes.

According to this construction, the addresses are successively formed from the inner circumferential side to the outer circumferential side of the optical disc medium on the first to (n/2)-th information planes, and the addresses are successively formed from the outer circumferential side to the inner circumferential side of the optical disc medium on the (n/2+1)-th to n-th information planes.

Thus, for example, in the case of an eight-layer information recording medium, information can be recorded or reproduced from the inner circumferential side to the outer circumferential side on the first to fourth information planes, an information can be recorded or reproduced from the outer circumferential side to the inner circumferential side on the fifth to eighth information planes.

In the above multi-layer information recording medium manufacturing method, the first to n-th information planes are preferably formed to approach a laser incident surface in this order. According to this construction, the first to n-th information planes can be formed to approach the laser incident surface.

### INDUSTRIAL APPLICABILITY

An multi-layer information recording medium, an information recording/reproducing device and a multi-layer information recording medium manufacturing method according to the present invention can assure lower compatibility with information recording media already on the market or of known formats, can record/reproduce information on/from a multi-layer information recording medium of a new format using an information recording/reproducing device already widely used, and are useful as an multi-layer information recording medium, which includes a plurality of layered information planes and on or from which information is recorded or reproduced by light, a manufacturing method for such a multi-layer information recording medium and an information recording/reproducing device for recording/reproducing information on/from such a multi-layer information recording medium.

1. A multi-layer information recording medium, comprising a plurality of layered information planes and adapted to record or reproduce information by light,
wherein the plurality of information planes include at least one information plane having a first reflecting surface for reflecting light with a first reflected light power when the light is incident and another information plane having a second reflecting surface for reflecting the light with a second reflected light power smaller than the first reflected light power.

2. A multi-layer information recording medium according to claim 1, wherein disc management information is recorded on the first reflecting surface.

3. A multi-layer information recording medium according to claim 1, further comprising an optical disc medium, wherein:
the second reflecting surface includes an inner circumferential area of the optical disc medium; and
the reflectivity of the inner circumferential area is lower than that of a data area for recording data.

4. A multi-layer information recording medium according to claim 1, further comprising an optical disc medium, wherein:
the first and second reflecting surfaces each include an inner circumferential area of the optical disc medium and a data area for recording data; and
the reflectivities of the inner circumferential area and the data area of the second reflecting surface are lower than those of the inner circumferential area and the data area of the first reflecting surface.

5. A multi-layer information recording medium according to claim 1, wherein:
the plurality of information planes include four information planes;
two of the four information planes reflect light with a specified first reflected light power when the light is incident on the first reflecting surface; and
the remaining two information planes reflect light with a second reflected light power smaller than the first reflected light power when the light is incident on the second reflecting surface.

6. (canceled)

7. A multi-layer information recording medium according to claim 1, wherein, if a ratio of the first reflected light power to an emitted light power on the first reflecting surface is a higher reflectivity ratio Rb and a ratio of the second reflected light power to an emitted light power on the second reflecting surface is a lower reflectivity ratio Rd, the lower reflectivity ratio Rd lies in a range of 0≦Rd<3.5% and the higher reflectivity ratio Rb lies in a range of 3.5%≦Rb≦8%.

8. A multi-layer information recording medium according to claim 7, wherein a relationship between the lower reflectivity ratio Rd and the higher reflectivity ratio Rb is 2×Rd<Rb.

9. A multi-layer information recording medium according to claim 7, wherein the lower reflectivity ratio Rd is sufficiently lower than the higher reflectivity ratio Rb and substantially 0.

10. A multi-layer information recording medium according to claim 1, further comprising an optical disc medium, wherein the first and second reflecting surfaces are provided in a range within 24 mm from the center of rotation of the optical disc medium.

11. A multi-layer information recording medium according to claim 10, wherein the first reflecting surface includes a BCA area for recording identification information peculiar to the multi-layer information recording medium by burst-cutting a reflective layer.

12. A multi-layer information recording medium according to claim 1, wherein the second reflecting surface is pre-recorded by laser light.

13. A multi-layer information recording medium according to claim 1, wherein the second reflecting surface is formed by burst-cutting a reflective surface.

14. A multi-layer information recording medium according to claim 1, wherein the second reflecting surface is formed with no reflective layer.

15. A multi-layer information recording medium according to claim 1, wherein a thickness between the respective adjacent information planes are 6 μm to 30 μm.

16. A multi-layer information recording medium according to claim 1, wherein disc management information is recorded at least at two positions of the first reflecting surface.

17. A multi-layer information recording medium according to claim 16, wherein areas where the disc management information is recorded are so arranged as not to overlap on the upper and lower information planes.

18. A multi-layer information recording medium according to claim 1, wherein:
a write-prohibit flag for prohibiting data recording in a user data area is recorded for each information plane; and
data recording on the information plane prohibited by the write-prohibit flag is prohibited.

19. A multi-layer information recording medium according to claim 1, wherein:
the plurality of information planes include the first to n-th information planes; and
recording or reproduction is performed from an inner circumferential side to an outer circumferential side of the optical disc medium on the information planes where MOD(n/4)=1, 2 (where MOD is a remainder when the numerical value n is divided by a divisor of 4) while being performed from the outer circumferential side to the inner circumferential side of the optical disc medium on the information planes where MOD(n/4)=3, 0.

20. A multi-layer information recording medium according to claim 19, wherein:
addresses are recorded from the inner circumferential side to the outer circumferential side of the optical disc medium on the information planes where MOD(n/4)=1, 2; and
addresses are recorded from the outer circumferential side to the inner circumferential side of the optical disc medium on the information planes where MOD(n/4)=3, 0.

21. A multi-layer information recording medium according to claim 1, wherein:
the plurality of information planes include the first to n-th information planes (n is an even number); and
recording or reproduction is performed from an inner circumferential side to an outer circumferential side of the optical disc medium on the first to (n/2)-th information planes while being performed from the outer circumferential side to the inner circumferential side of the optical disc medium on the (n/2+1)-th to n-th information planes.

22. A multi-layer information recording medium according to claim 21, wherein:
addresses are recorded from the inner circumferential side to the outer circumferential side of the optical disc medium on the first to (n/2)-th information planes; and
addresses are recorded from the outer circumferential side to the inner circumferential side of the optical disc medium on the (n/2+1)-th to n-th information planes.

23. A multi-layer information recording medium according to claim 19, wherein the first to n-th information planes are formed to approach a laser incident surface in this order.

24. An information recording/reproducing device for recording or reproducing information on or from a multi-layer information recording medium including a plurality of layered information planes, the plurality of information planes including at least one information plane having a first reflecting surface for reflecting light with a first reflected light power when the light is incident and another information plane having a second reflecting surface for reflecting the light with a second reflected light power smaller than the first reflected light power, the information recording/reproducing device comprising:
a laser light emitter for emitting laser light for recording or reproducing a signal on or from a signal track of the multi-layer information recording medium;
a spherical aberration correcting section for correcting the spherical aberration of the laser light;
a controller for controlling the focal position of the laser light according to the information plane, to which the laser light is emitted; and
a medium discriminator for discriminating the number of the information planes by emitting laser light to the first reflecting surface of the multi-layer information recording medium.

25. An information recording/reproducing device according to claim 24, wherein the medium discriminator discriminates the number of the information planes from waveform information of a focus error signal.

26. An information recording/reproducing device according to claim 24, further comprising:
a flag setting section for setting a write-prohibit flag for prohibiting data recording in a user data area for each information plane; and
a recording section for not recording data on the information plane for which the write-prohibit flag is set by the flag setting section.

27. A multi-layer information recording medium manufacturing method for manufacturing a multi-layer information recording medium including a plurality of layered information planes, comprising:
a first step of forming a reflective layer on a substrate formed with an information plane on one side;
a second step of forming a transparent intermediate layer having an information plane on the reflective layer;
a third step of forming a reflective layer on an information plane side of the intermediate layer;
a fourth step of forming a transparent protective layer after the plurality of information planes are formed by repeating the second and third steps a plurality of times; and
a fifth step of forming a first reflecting surface, which reflects light with a specified first reflected light power when the light is incident, on at least one information plane and forming a second reflecting surface, which reflects the light with a second reflected light power smaller than the first reflected light power, on another information plane.

28. A multi-layer information recording medium manufacturing method according to claim 27, wherein the second reflecting surface is formed by pre-recording on the other information plane by laser light in the fifth step.

29. A multi-layer information recording medium manufacturing method according to claim 27, wherein the second reflecting surface is formed by burst-cutting the reflective layer beforehand by laser light in the fifth step.

30. A multi-layer information recording medium manufacturing method according to claim 27, wherein the second reflecting surface is formed by masking the other information plane upon forming the reflective layer in the first and third steps.

31. A multi-layer information recording medium manufacturing method according to claim 27, wherein:
the plurality of information planes include the first to n-th information planes; and
the information planes where MOD(n/4)=1, 2 (where MOD is a remainder when the numerical value n is divided by a divisor of 4) and the information planes where MOD(n/4)=3, 0 are formed such that spiral directions are opposite.

32. A multi-layer information recording medium manufacturing method according to claim 31, wherein:
addresses are successively formed from an inner circumferential side to an outer circumferential side of the optical disc medium on the information planes where MOD(n/4)=1, 2; and
addresses are successively formed from the outer circumferential side to the inner circumferential side of the optical disc medium on the information planes where MOD(n/4)=3, 0.

33. A multi-layer information recording medium manufacturing method according to claim 27, wherein:
the plurality of information planes include the first to n-th information planes (n is an even number); and
the first to (n/2)-th information planes and the (n/2+1)-th to n-th information planes are formed such that spiral directions are opposite.

34. A multi-layer information recording medium manufacturing method according to claim 33, wherein:
addresses are successively formed from an inner circumferential side to an outer circumferential side of the optical disc medium on the first to (n/2)-th information planes; and
addresses are successively formed from the outer circumferential side to the inner circumferential side of the optical disc medium on the (n/2+1)-th to n-th information planes.

35. A multi-layer information recording medium manufacturing method according to claim 31, wherein the first to n-th information planes are formed to approach a laser incident surface in this order.
